(19) United States
(12) Patent Application Publication
(10) Pub. No.: US 2026/0247493 A1
(43) Pub. Date: Aug. 20, 2026

(54) Functional Cap for Heating and Dispensing Skincare Liquids

(71) Applicant: SHENZHEN NUON MEDICAL EQUIPMENT CO., LTD., Shenzhen (CN)

(72) Inventors: Alain Dijkstra, Amstelveen (NL); Li Xiang, Shenzhen (CN)

(73) Assignee: Shenzhen Nuon Medical Equipment Co., Ltd., Shenzhen (CN)

(21) Appl. No.: 19/537,770

(22) Filed: Feb. 12, 2026

(30) Foreign Application Priority Data
Feb. 14, 2025 (CN) 2025101685362
Feb. 14, 2025 (CN) 2025202405631
Feb. 14, 2025 (CN) 2025202457439

(51) Int. Cl. H05B 3/06; B65D 47/06; H05B 3/16

(52) U.S. Cl. CPC H05B 3/06; B65D 47/06; B65D 47/065; H05B 3/16

(57) ABSTRACT

Embodiments of the present invention disclose a functional cap for heating and dispensing skincare liquids, configured to be detachably or fixedly mounted on a container storing a liquid skincare product. The functional cap integrates a heating assembly, a liquid guide tube, and a liquid suction and discharge component, enabling selective intake, localized heating, and controlled dispensing of a predetermined amount of skincare liquid without heating the entire contents of the container. A heating chamber is arranged within the cap and cooperates with one or more heating elements to rapidly heat only the extracted liquid. A valve-controlled flow structure regulates liquid and air flow during extraction, heating, and dispensing stages, reducing residual liquid effects and improving heating efficiency. Additionally, temperature sensing and control components ensure safe and stable heating.

### TECHNICAL FIELD

The present invention relates to the field of skincare product packaging and dispensing devices, and more particularly to a functional cap for skincare liquid bottles, wherein the cap integrates a heating assembly and a liquid dispensing mechanism for selectively heating and dispensing skincare liquids at the time of use.

### BACKGROUND ART

Skincare products such as serums, essential oils, lotions, and medical or nursing liquids are widely used for cosmetic, therapeutic, and dermatological applications. Liquid skincare products are necessities in people's daily lives. However, skincare products at room temperature are not easily absorbed by the skin, and users often need to massage for a long time to promote absorption, which is time-consuming and laborious, resulting in a poor user experience. Additionally, in cold weather, the temperature of these products can be too low, causing skin irritation and discomfort upon application.

To address this issue, skincare products are typically heated to maintain a comfortable temperature upon dispensing. For effective absorption and user comfort, these products are often preferred at a warmed or temperature-controlled state during application. However, most skincare containers currently available in the market are passive storage vessels and do not provide any integrated means for controlled heating of the product at the time of use.

Existing solutions that attempt to warm skincare products typically rely on external heating devices, such as water baths, heating pads, or electric warmers that heat the entire bottle. When users apply skincare products such as essential oils and serums, they often heat the entire bottle using a heating device to improve absorption. However, this process involves repeatedly heating the entire bottle each time a user needs to use the product. Such repeated bulk heating of the stored product can adversely affect product stability, degrade active ingredients, alter chemical composition, and reduce shelf life. This repeated heating to high temperatures negatively impacts the stability of the product's properties and accelerates its deterioration. Moreover, these methods are inconvenient, time-consuming, and difficult to control precisely, resulting in inconsistent temperatures, longer waiting times, and a poor user experience.

Some known container caps incorporate heating elements; however, these designs often lack precise control over the amount of product being heated, or they require complex structures that are bulky, inefficient, or unsuitable for daily consumer use. In many cases, the heating mechanism affects the entire container rather than selectively heating only the portion of the product intended for immediate application. Additionally, existing designs may fail to address issues such as residual liquid remaining in the liquid guide tube after extraction, which can affect the temperature of the heated product. Other issues include heat loss during transfer, contamination risks, inadequate sealing, or compatibility with different container formats.

Accordingly, there exists a need for a compact, integrated skincare product container system that is capable of selectively heating only the required quantity of the product at the point of dispensing, while maintaining the remaining product at ambient conditions. There is also a need for such a system to be efficient, safe, reusable, and adaptable to various skincare formulations without compromising product integrity. Furthermore, there is a need for a solution that addresses the problem of residual liquid in the liquid guide tube, affecting the temperature accuracy of the heated product.

The present invention addresses these shortcomings by providing an improved functional cap and container system in which a heating structure is integrated within the cap and cooperates with a liquid guiding and suction/discharge mechanism. The invention enables a predetermined amount of skincare product to be drawn from the container into a heating region where it is heated rapidly and uniformly before dispensing. By localizing the heating process within the cap and avoiding bulk heating of the entire container, the invention preserves the quality of the stored product while significantly reducing waiting time and energy consumption.

### OBJECTS OF THE INVENTION

Some of the objects of the invention are as follows:

An object of the present invention is to provide a functional cap for heating and dispensing skincare liquids, which enables selective and localized heating of a predetermined quantity of skincare liquid within a dedicated heating chamber, without heating the entire contents of the bottle body.

Another object of the present invention is to provide a functional cap integrating a heating assembly, a liquid guide tube, and a stop-flow vent valve, thereby enabling controlled intake, heating, retention, and dispensing of skincare liquid in a single compact structure.

A further object of the present invention is to provide a functional cap having a heating chamber and a heating element configured to rapidly and uniformly heat only the skincare liquid intended for immediate use, while preserving the quality, stability, and efficacy of the remaining skincare liquid stored in the bottle body.

Another object of the present invention is to provide a valve-controlled liquid and air flow system including a valve body and a movable valve core, capable of switching between multiple positions to control liquid and air communication, thereby preventing backflow, reducing residual liquid retention in the liquid guide tube, and improving heating efficiency and dispensing accuracy.

Another object of the present invention is to provide a functional cap in which residual skincare liquid present in the liquid guide tube can be discharged while retaining a predetermined amount of skincare liquid within the heating chamber for heating, thereby improving temperature precision and reducing user waiting time.

A further object of the present invention is to provide a functional cap having a heat insulation box, a heat-conducting seat, and a thermally conductive structural layer, so as to enhance heat transfer efficiency, reduce thermal loss, and ensure uniform temperature distribution within the heating chamber.

Another object of the present invention is to provide a functional cap compatible with various liquid suction and discharge components, including a pressing cap, dropper, pump, push-pull rod, and piston structure, thereby enabling precise dosage control and ease of operation.

A still further object of the present invention is to provide a functional cap incorporating a temperature sensor and a control circuit configured to maintain the skincare liquid within a preset safe temperature range suitable for skin application, thereby enhancing safety and protecting active ingredients from overheating.

Another object of the present invention is to provide a functional cap including a liquid guide tube having a telescopic or segmented structure, thereby allowing adaptation to bottle bodies of different sizes and depths.

Yet another object of the present invention is to provide a compact, energy-efficient, and industrially applicable skincare liquid heating and dispensing cap suitable for cosmetic, skincare, pharmaceutical, and personal care product packaging in residential, commercial, and professional environments.

### SUMMARY OF THE INVENTION

According to a first aspect of the present invention, a functional cap for heating and dispensing skincare liquids is provided. The functional cap comprises: a cap body configured to attach to a bottle body; a heating assembly disposed within the cap body, the heating assembly comprising a heating chamber and a heating element configured to heat the heating chamber; a liquid guide tube connected to the heating chamber, wherein one end of the liquid guide tube remote from the heating chamber is configured to extend into the bottle body; and a stop-flow vent valve connected between the heating chamber and the liquid guide tube, the stop-flow vent valve comprising a valve body and a valve core, wherein the valve core is movable to control liquid and air flow.

In one embodiment, the heating element comprises one of a heating wire, a heating plate, a heating rod, a heating film, or a ceramic heating element.

In one embodiment, the functional cap further comprises a liquid suction and discharge component disposed on the cap body and connected to the heating chamber, wherein the liquid suction and discharge component is configured to control skincare liquid in the bottle body to be drawn into the heating chamber or to control skincare liquid in the heating chamber to be discharged.

In one embodiment, the liquid suction and discharge component comprises one of a pressing cap, a dropper, a pump disposed on the cap body and connected to the heating chamber, or a push-pull rod and a piston, wherein the piston is slidably disposed within the heating chamber, and wherein the push-pull rod is connected to the piston and extends through the cap body.

In one embodiment, the liquid guide tube comprises a plurality of tube segments sequentially connected and configured to extend or retract relative to one another.

In one embodiment, the heating assembly comprises a phase-change material configured to release heat during a phase transition.

In one embodiment, the heating assembly further comprises a heat insulation box surrounding the heating chamber, wherein the heating element is disposed between the heating chamber and the heat insulation box.

In one embodiment, the heating assembly further comprises a heat-conducting seat disposed within the heat insulation box, the heat-conducting seat being sleeved around the heating chamber, and wherein the heating element is mounted on the heat-conducting seat.

In one embodiment, the functional cap further comprising a thermally conductive structure layer disposed between the heat-conducting seat and the heating chamber.

In one embodiment, the valve body includes a main flow chamber and a bypass chamber, wherein one end of the main flow chamber is connected to the heating chamber and another end of the main flow chamber is connected to the liquid guide tube, wherein a first vent is formed between the bypass chamber and the main flow chamber, and wherein a second vent is formed on a side of the bypass chamber at a distance from the first vent, and wherein the valve core is movable within the bypass chamber to switch between a first position blocking the first vent, a second position opening both the first vent and the second vent, and a third position blocking the second vent.

According to a second aspect of the present invention, a functional cap for heating and dispensing skincare liquids is provided. The functional cap comprising: a cap body configured to attach to a bottle body; a liquid guide tube and a liquid suction and discharge component, wherein the liquid guide tube includes a first end, a second end, and a heating chamber comprising a heat-conducting part disposed between the first end and the second end, wherein the heat-conducting part is disposed within the cap body, wherein the first end passes through the cap body and is configured to extend into the bottle body, and wherein the liquid suction and discharge component is connected to the second end and exposed on the cap body, the liquid suction and discharge component configured to draw skincare liquid from the bottle body into the heat-conducting part through the first end or to discharge skincare liquid from the heat-conducting part through the first end; and a heating structure comprising a heating element disposed on the heat-conducting part.

In one embodiment, the heat-conducting part is spiral-shaped, and the heating element is selected from a heating wire, a heating plate, or a heating rod, wherein the heating element is arranged along and wound around the heat-conducting part.

In one embodiment, the functional cap further comprising a heat-insulating structure disposed inside the cap body and configured to insulate the heat-conducting part, wherein the heat-insulating structure comprises an insulation box surrounding the heat-conducting part.

In one embodiment, the functional cap further comprising an insulation column that fills a central space of the heat-conducting part.

In one embodiment, the functional cap further comprising a temperature sensor disposed on the heat-conducting part and a circuit board disposed within the cap body and electrically connected to the temperature sensor and the heating element.

According to a third aspect of the present invention, a functional cap for heating and dispensing skincare liquids is provided. The functional cap comprising: a cap body configured to attach to a bottle body; a heating chamber disposed within the cap body; a liquid guide tube connected to the heating chamber, wherein one end of the liquid guide tube is configured to extend into the bottle body; a liquid suction and discharge component disposed on the cap body and connected to the heating chamber; and a stop-flow vent valve connected between the heating chamber and the liquid guide tube, the stop-flow vent valve configured to discharge residual skincare liquid from the liquid guide tube while retaining skincare liquid in the heating chamber for heating.

In one embodiment, the stop-flow vent valve comprises a valve body including a main flow chamber and a bypass chamber, wherein one end of the main flow chamber is connected to the heating chamber and another end of the main flow chamber is connected to the liquid guide tube, wherein a first air hole is connected between the bypass chamber and the main flow chamber, and wherein a second air hole is provided on a side of the bypass chamber remote from the first air hole.

In one embodiment, the functional cap further comprising a valve core movably disposed within the bypass chamber and configured to switch between a first position blocking the first air hole, a second position opening both the first air hole and the second air hole, and a third position blocking the second air hole.

In one embodiment, during a skincare liquid extraction stage, the valve core moves to the first position to seal the first air hole; wherein during a stopping extraction stage, the valve core moves to the second position to connect the first air hole and the second air hole, allowing residual skincare liquid in the liquid guide tube to drain by gravity while retaining skincare liquid in the heating chamber; and wherein during a skincare liquid discharge stage, the valve core moves to the third position to block the second air hole.

In one embodiment, the stop-flow vent valve is selected from a group consisting of but is not limited to a non-return valve (NRV), check valve, one-way valve, duckbill valve, diaphragm valve, spring-loaded valve, gravity-biased valve, solenoid valve.

In the context of the specification, the term “functional cap,” “heating cap,” or “bottle cap” refers to the cap assembly configured to attach to a bottle body and perform heating and dispensing of skincare liquids. The term “heating element” refers to any electrical or thermal component capable of generating heat for transfer to the heating chamber. The term “liquid suction and discharge component” refers broadly to any structure capable of generating negative or positive pressure to control liquid flow.

In the context of the specification, when an element is referred to as being “fixed to” or “disposed to” another element, it may either be directly on another element or indirectly on that other element. When a component is said to be “connected” or “connected to” another component, it may be directly connected to another component or indirectly connected to other components on the piece.

In the context of the specification, the terms “first”, “second,” and “third” are only used for descriptive purposes and do not imply the relative importance or implicitly indicate the quantity of technical features indicated.

In the context of the specification, the term “plurality” means two or more than two, unless otherwise indicated.

In the context of the specification, the term "several" means more than one, unless otherwise specified.

In the context of the specification, the term "functional cap," "heating cap," or "bottle cap" refers to the cap assembly of the present invention configured to attach to a bottle body and perform heating and dispensing of skincare liquids.

In the context of the specification, the term “stimulation element” refers broadly to any component, module, or structure configured to apply a therapeutic or cosmetic stimulus to a user’s skin or tissue. Stimulation elements may include, but are not limited to, phototherapy elements, massage elements, an electrical stimulation element for providing EMS therapy, Microcurrent therapy, galvanic therapy, Tens therapy, RF therapy, ultrasonic transducers, heating elements, cooling elements, or therapy combinations thereof.

In an embodiment, the heating element is configured to heat the skincare liquid to a temperature within a preset safe range suitable for skin application, such as approximately 36°C to 40°C. The temperature sensor provides accurate temperature readings to ensure that the temperature during the heating process does not exceed the set safe range. When the temperature sensor detects that the temperature has reached the set value, the circuit board automatically reduces or stops the power output of the heating element to avoid overheating. Conversely, when the temperature is lower than the set value, heating is resumed. This precise temperature control prevents the destruction of active ingredients in essential oils or other skincare products due to overheating, maintaining the product's optimal effect and preventing the risk of burns during use, thus improving product safety.

In the context of the specification, the term “phototherapy element” encompasses any light-emitting device capable of emitting light of therapeutic wavelength(s), including but not limited to light-emitting diodes (LEDs), organic LEDs (OLEDs), laser diodes, or equivalent optical sources. The light may include ultraviolet, visible, near-infrared, or far-infrared spectra.

In the context of the specification, the term “housing” is intended to cover any casing, enclosure, or structural body that contains or supports components of the device. The housing may include a handle portion, head portion, or other segments, and may be made from polymeric, metallic, composite, or other suitable materials.

In the context of the specification, the term “light-emitting element,” “phototherapy unit,” or “light-transmitting surface” refers to a component configured to emit light for skin treatment.

In the context of the specification, the term "mounting part," "mounting hole," or "mounting port" refers to a structure configured to hold, position, or support components such as the liquid suction and discharge assembly or the heating assembly within the cap body.

In the context of the specification, the term “sealing pad,” “retaining ring”, or “gasket” refers to a component configured to provide a sealed connection between structural elements, preventing liquid or mist leakage.

In the context of the specification, the term "LED module" refers to one or more light-emitting diode (LED) elements that are electrically connected and configured to emit light of specific wavelengths suitable for therapeutic purposes. The LED module may include drive circuitry, heat dissipation structures, and optical elements such as lenses or diffusers to control light distribution.

In the context of the specification, the term “light source” or “phototherapy source” etc. refers to a source emitting coherent laser light, or light-emitting diodes (“LEDs”). The term “light therapy” refers to light generated from any of the sources, such as lasers, LED sources, or Super luminous diodes (“SLD”).

In the context of the specification, “Light Emitting Diodes (LEDs)” refer to semiconductor diodes capable of emitting electromagnetic radiation when supplied with an electric current. The LEDs are characterized by superior power efficiencies, smaller sizes, rapid switching speeds, physical robustness, and longer lifespans compared to incandescent or fluorescent lamps. The one or more LEDs may include through-hole type LEDs (generally emitting electromagnetic radiation in red, green, yellow, blue, and white colors), Surface Mount Technology (SMT) LEDs, Bi-color LEDs, Pulse Width Modulated RGB (Red-Green-Blue) LEDs, and high-power LEDs, among others.

Materials used in one or more LEDs may vary from one embodiment to another, depending upon the frequency of radiation required. Different frequencies can be obtained from LEDs made from pure or doped semiconductor materials. Commonly used semiconductor materials include nitrides of Silicon, Gallium, Aluminum, Boron, Zinc Selenide, etc., in pure form or doped with elements such as Aluminum and Indium. For example, red and amber colors are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used to generate a wider color gamut. White and other colored lightings may also be produced using phosphor coatings such as Yttrium Aluminum Garnet (YAG) in combination with a blue LED to generate white light, and Magnesium-doped potassium fluorosilicate in combination with a blue LED to generate red light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, a discussion on the generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety by reference.

Unless otherwise stated, the term “light” as used in this specification encompasses electromagnetic radiation in the visible (380–780 nm) and infrared (780 nm–1000 nm) ranges, particularly red light (620–750 nm) and near-infrared (750–1400 nm) wavelengths commonly used in photobiomodulation therapy. Particular wavelengths which may be selected as the dominant emissive wavelength may include the follow, without any preference to be indicated by order: 400 nm, 405 nm, 420 nm, 430 nm, 450 nm, 465 nm, 515 nm, 530 nm, 532 nm, 590 nm, 630 nm, 633 nm, 640 nm, 650 nm, 655 nm, 660 nm, 670 nm, 680 nm, 780 nm, 785 nm, 810 nm, 830 nm, 840 nm, 850 nm, 860 nm, 870 nm, 904 nm, 915 nm, 980 nm, 1015 nm, 1060 nm, 1065 nm, 1070 nm, 1200, and 1400 nm. As used herein, the term “light therapy” refers to the use of one or more light sources of any type that emit light with a wavelength between about 400 and 1400 nm. The device may also emit blue or ultraviolet light for surface-level treatments such as acne reduction or microbial control.

The red light (approximately 630–660 nm) penetrates deeply into the scalp to stimulate blood circulation and enhance hair follicle activity, thus promoting hair growth and repair. Blue light (around 415–470 nm) exhibits antibacterial properties and is effective in treating scalp acne and reducing inflammation. Green light (approximately 520–540 nm) can help reduce pigmentation and soothe sensitive or irritated scalp tissue. Yellow light (around 580–600 nm) improves oxygen exchange in the cells and aids in detoxifying the scalp, while near-infrared light (800–850 nm) reaches deeper layers to accelerate healing and reduce pain.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings, wherein like reference letters and numerals indicate the corresponding parts in various figures in the accompanying drawings, and in which:

FIG. 1A shows a perspective view of a functional cap and a bottle body in a closed state, in accordance with an embodiment of the present invention.

FIG. 1B shows a perspective view of an alternate configuration of the functional cap and the bottle body in a closed state, in accordance with an embodiment of the present invention.

FIG. 2 illustrates a perspective view of the functional cap and the bottle body in an open state, in accordance with an embodiment of the present invention.

FIG. 3A shows a cross-sectional view of the functional cap with a stop-flow vent valve, and the bottle body in a partially open state, in accordance with an embodiment of the present invention.

FIG. 3B shows a cross-sectional view of the functional cap and the bottle body in a partially open state, in accordance with an embodiment of the present invention.

FIG. 3C shows a cross-sectional view of the functional cap with a spiral-shaped heating chamber and the bottle body in a partially open state, in accordance with an embodiment of the present invention.

FIG. 4A shows an exploded view of the functional cap with a stop-flow vent valve, in accordance with an embodiment of the present invention.

FIG. 4B shows an exploded view of the functional cap, in accordance with an embodiment of the present invention.

FIG. 4C shows an exploded view of the functional cap with a spiral-shaped heating chamber, in accordance with an embodiment of the present invention.

FIG. 5 shows a stop-flow vent valve of the functional cap, in accordance with an embodiment of the present invention.

FIG. 6A, 6B, and 6C illustrate a cross-sectional view of the stop-flow vent valve showing the working principle of a valve-core, in accordance with an embodiment of the present invention.

FIG. 7 shows a cross-sectional view of a heating element mounted over the heating chamber, in accordance with an embodiment of the present invention.

FIG. 8 shows an exploded view of the heating element of FIG. 7, in accordance with an exemplary embodiment of the present invention.

FIG. 9 shows another configuration of the heating element, in accordance with an exemplary embodiment of the present invention.

FIG. 10 shows another configuration of the heating element, in accordance with an exemplary embodiment of the present invention.

FIG. 11 illustrates a cross-sectional view of another configuration of the heating element, in accordance with an exemplary embodiment of the present invention.

FIG. 12A shows a spiral-shaped heating chamber around a vertical axis of the liquid guide tube, in accordance with an embodiment of the present invention.

FIG. 12B shows a spiral-shaped heating chamber around a horizontal axis of the liquid guide tube, in accordance with an embodiment of the present invention.

FIG. 13 shows a retractable liquid guide tube having a plurality of tube segments arranged in a telescopic manner, in accordance with an embodiment of the present invention.

FIG. 14 shows the liquid guide tube of FIG. 13, with the plurality of tube segments retracted in a closed state, in accordance with an embodiment of the present invention.

FIG. 15 illustrates an alternate configuration of the functional cap and a bottle body, in accordance with an embodiment of the present invention.

FIG. 16 shows a cross-sectional view of the functional cap and the bottle body of FIG. 15, in accordance with an embodiment of the present invention.

FIG. 17 shows interior components of the functional cap of FIG. 15, with an outer shell removed, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the specification may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention provide a functional cap for heating and dispensing skincare liquids, configured to be detachably or fixedly mounted on a container storing a liquid skincare product. The functional cap serves as an integrated operating unit that performs selective heating, controlled liquid intake, and regulated dispensing of the skincare liquid, thereby enabling the user to obtain a warmed quantity of product at the time of use without heating the entire contents of the container.

In an embodiment, the functional cap comprises a cap body defining an internal accommodation space, a heating assembly disposed within the cap body, and a liquid dispensing system in fluid communication with the container. The cap body is configured to engage a mouth portion of a bottle or container in a sealed manner, such that the internal components of the cap are isolated from the external environment while maintaining reliable fluid communication with the liquid stored in the container.

The liquid dispensing system is arranged to control the movement of skincare liquid between the container and a heating region formed within the cap. In particular, the dispensing system may include a suction and discharge mechanism operable by manual actuation or powered actuation, and a valve assembly arranged along a fluid path between the container and the heating region. The valve assembly is configured to selectively permit, restrict, or interrupt liquid flow and air flow during different operational stages, such as liquid intake, heating, and dispensing, thereby preventing leakage, backflow, or unintended discharge.

In an embodiment, the valve assembly comprises a multi-chamber valve structure and a movable valve core that changes position in response to pressure variation or actuation of the dispensing mechanism. Through coordinated control of air passages and liquid passages, the valve assembly enables accurate metering of the skincare liquid, stabilizes the liquid within the heating region during heating, and ensures smooth and controlled dispensing of the heated liquid during use.

The heating assembly is arranged within the cap body and is configured to heat only the portion of skincare liquid drawn into the cap, without substantially affecting the temperature of the remaining liquid stored in the container. The heating assembly may include a heating chamber configured to temporarily receive the skincare liquid and one or more heating elements arranged to transfer thermal energy to the liquid. The heating elements may be in direct contact with the heating chamber to enable efficient transfer of heat to the skincare product.

In an embodiment, the heating assembly may take different structural forms, including but not limited to electrically powered resistance heating elements, spiral or annular heating elements arranged around a liquid passage, heat-conducting seats or sleeves, insulated heating chambers, or combinations thereof. Optional temperature sensing and control components may be provided to regulate heating temperature, improve heating uniformity, and ensure user safety and product stability.

The functional cap further includes a liquid guide tube extending between the container and the heating chamber. The liquid guide tube structure defines a fluid passage through which the skincare liquid is drawn from the container into the heating region and subsequently discharged. The liquid guide tube may be formed as a single continuous structure or as multiple liquid guide tube sections that are sequentially connected and capable of extending or retracting relative to one another. In an embodiment, portions of the tube may be arranged in a spiral, coiled, or elongated configuration to enhance heat transfer efficiency, minimize heat loss, or improve the compactness of the cap structure.

Through the coordinated arrangement of the cap body, valve-controlled dispensing mechanism, heating assembly, and liquid guide tube structure, the present invention achieves rapid, controlled heating and dispensing of skincare liquids while preserving the quality of the remaining product in the container and significantly improving user convenience and experience.

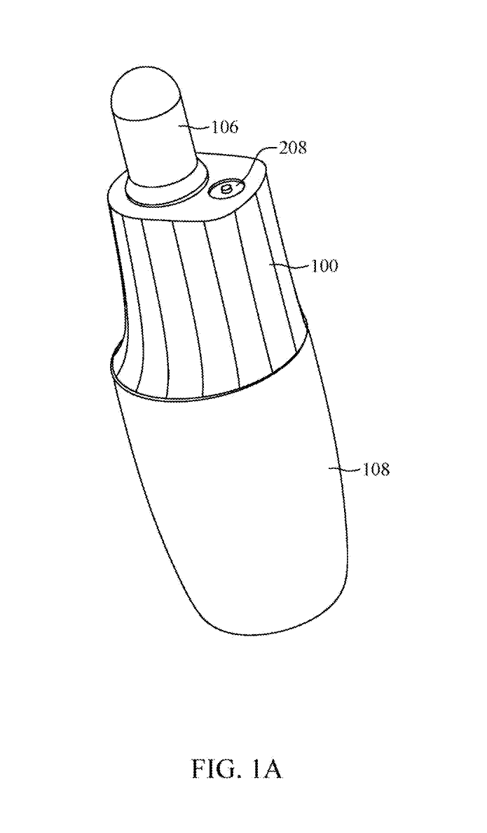

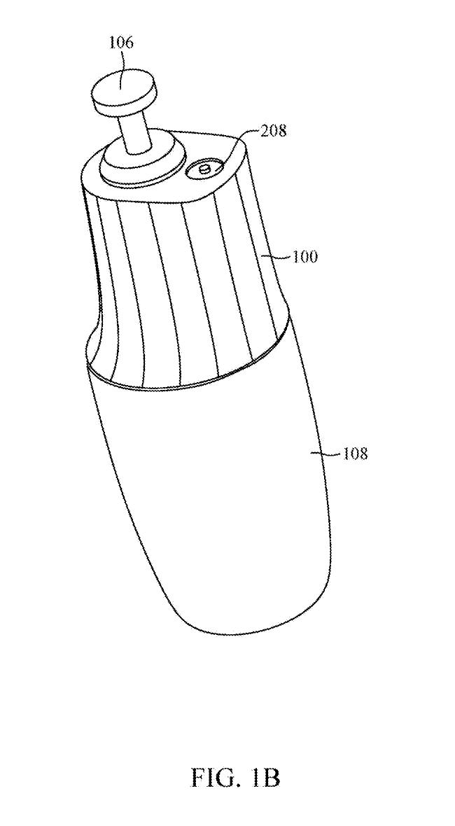

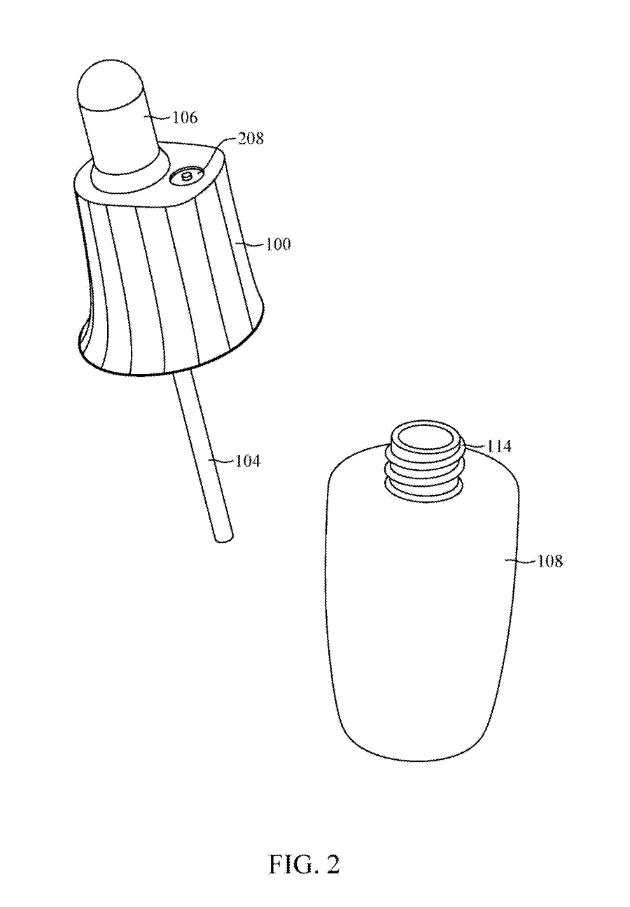

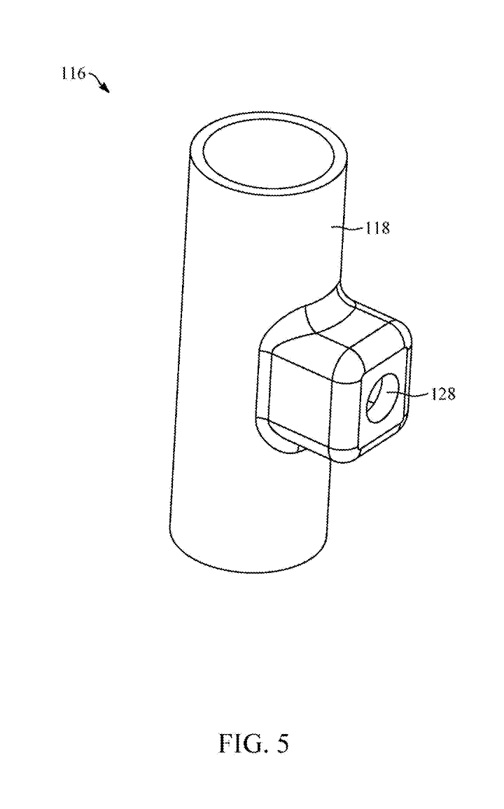

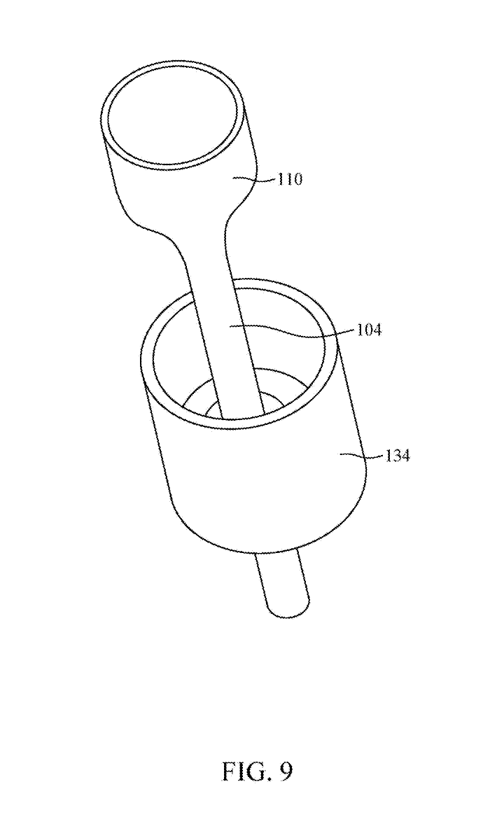

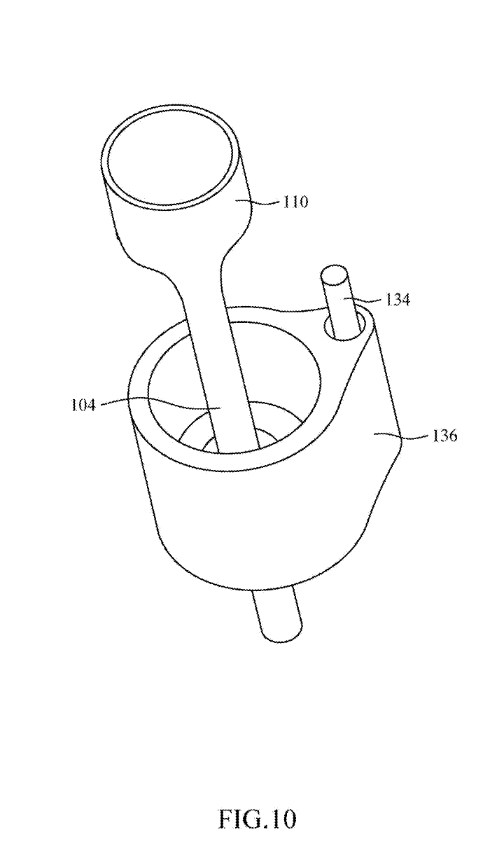

Referring to FIGS. 1A to 17, in an embodiment, the present invention provides a functional cap, comprising a cap body 100, a heating assembly 102, a liquid guide tube 104, and a liquid suction and discharge component 106. The cap body 100 is detachably or fixedly connected to a bottle body 108. The heating assembly 102 is disposed within the cap body 100 and includes a heating chamber 110 and a heating element 134, wherein the heating element 134 is configured to heat skincare liquid accommodated in the heating chamber 110.

In an embodiment, the liquid guide tube 104 is fluidly connected to the heating chamber 110, and the opposite end of the liquid guide tube 104 extends into the interior of the bottle body 108. The liquid suction and discharge component 106 is arranged on the cap body 100 and is fluidly connected to the heating chamber 110, and is configured to selectively control intake of skincare liquid from the bottle body 108 into the heating chamber 110 and discharge of the heated skincare liquid from the heating chamber 110 for user application.

In an embodiment, the cap body 100 serves as a primary structural carrier of the functional cap. The cap body 100 is configured to be mounted on a bottle mouth portion 114 at the top portion of the bottle body 108, thereby supporting and positioning the heating assembly 102, the liquid guide tube 104, and the liquid suction and discharge component 106. The heating chamber 110 is formed within the cap body 100 and defines a confined space for temporarily storing a predetermined quantity of skincare liquid. The heating element 134 may be implemented as a resistance heating wire, heating sheet, heating rod, or other electrically driven heating element, and is arranged to directly or indirectly transfer heat to the heating chamber 110, thereby raising the temperature of the skincare liquid contained therein.

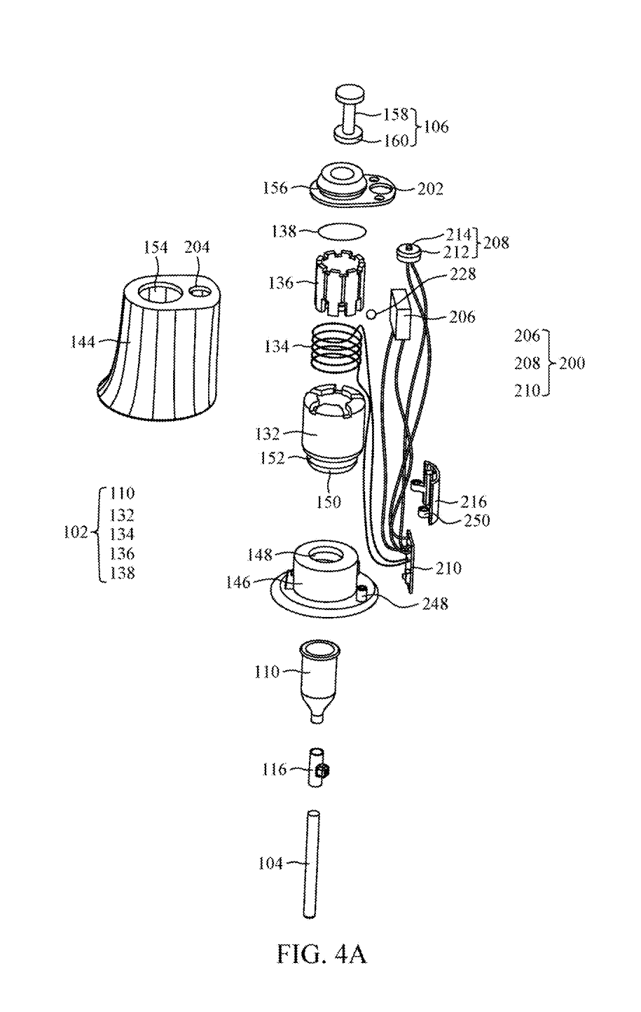

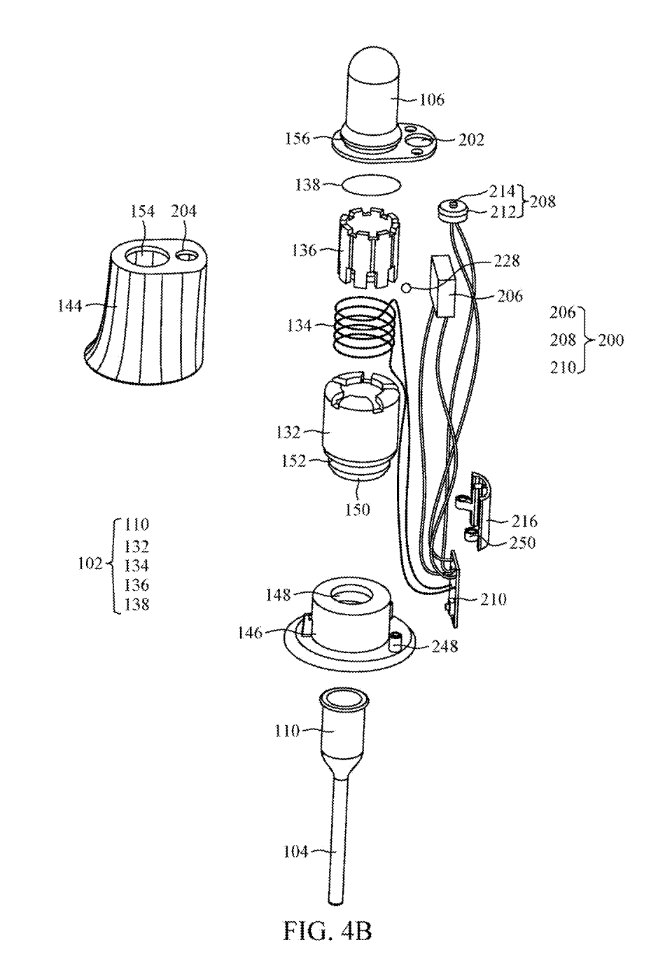

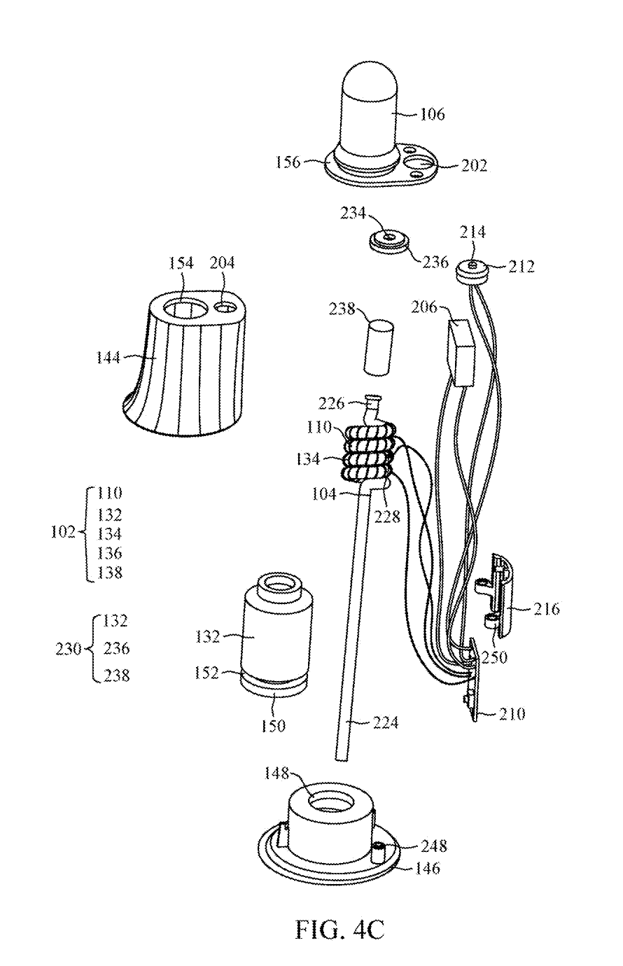

Referring to FIGS. 4A and 4B, the liquid guide tube 104 establishes a fluid passage between the interior of the bottle body 108 and the heating chamber 110, enabling skincare liquid to be drawn upward from the bottle body 108 into the heating chamber 110.

The liquid guide tube 104 and the heating chamber 110 are either formed as a single, integrally molded structure or as separate components that are fluidly connected.

Referring to FIG. 4C, the cap body 100 is detachably or fixedly connected to the bottle body 108 configured to store skincare products such as serums, essences, oils, or other liquid formulations, thereby ensuring stable attachment and effective sealing between the cap body 100 and the bottle body 108.

The liquid guide tube 104 includes a first end 224, a second end 226, and the heating chamber 110 is positioned between the first end 224 and the second end 226.

The first end 224 of the liquid guide tube 104 extends through the cap body 100 into the interior of the bottle body 108, allowing the skincare product to be drawn upward from the bottle body 108. The second end 226 of the liquid guide tube 104 is exposed outside the cap body 100 and is operatively connected to the liquid suction and discharge component 106, enabling user-controlled suction and discharge of the skincare product.

The liquid suction and discharge component 106 is configured to control both the suction of skincare liquid into the heating chamber 110 and the discharge of the heated skincare liquid after heating. The liquid suction and discharge component 106 may be a manual or automatic actuation structure, such as a squeeze mechanism, piston mechanism, push-pull rod, or other suitable driving means, enabling the user to precisely control the volume of skincare liquid being heated and dispensed.

During use, when a user intends to heat a certain quantity of skincare liquid, the liquid suction and discharge component 106 is actuated to draw an appropriate amount of skincare liquid from the bottle body 108 through the liquid guide tube 104 and into the heating chamber 110. The heating element 134 is then energized to heat only the skincare liquid within the heating chamber 110. After heating is completed, the liquid suction and discharge component 106 is actuated again to discharge the heated skincare liquid from the heating chamber 110 for immediate use by the user.

By heating only the portion of skincare liquid intended for immediate application, the functional cap effectively avoids repeated heating of the entire contents of the bottle body 108, thereby reducing thermal degradation of active ingredients, improving heating efficiency, and shortening user waiting time. Consequently, the functional cap ensures consistent product quality while delivering an improved and convenient skincare experience.

In practical operation, although the skincare liquid within the heating chamber 110 is directly heated by the heating element 134, a portion of the skincare liquid may remain within the liquid guide tube 104. When the liquid guide tube 104 is relatively long or when the ambient temperature is low, the residual liquid within the liquid guide tube 104 may adversely affect the heating efficiency or temperature stability of the skincare liquid within the heating chamber 110.

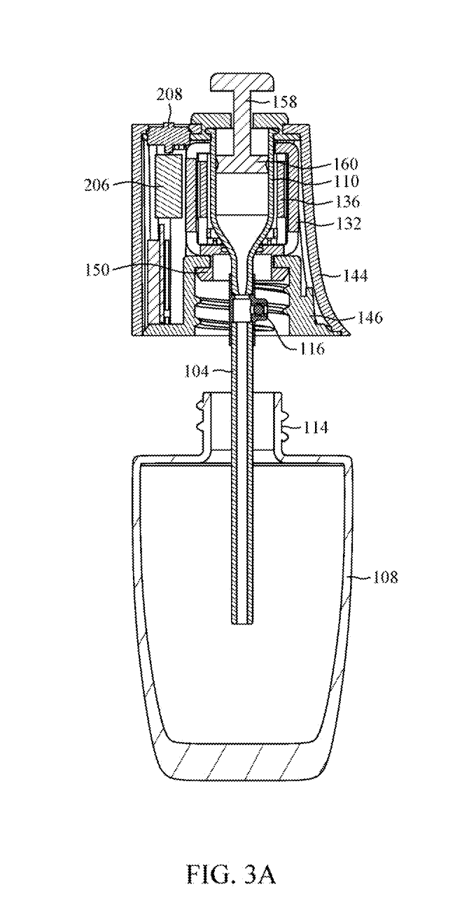

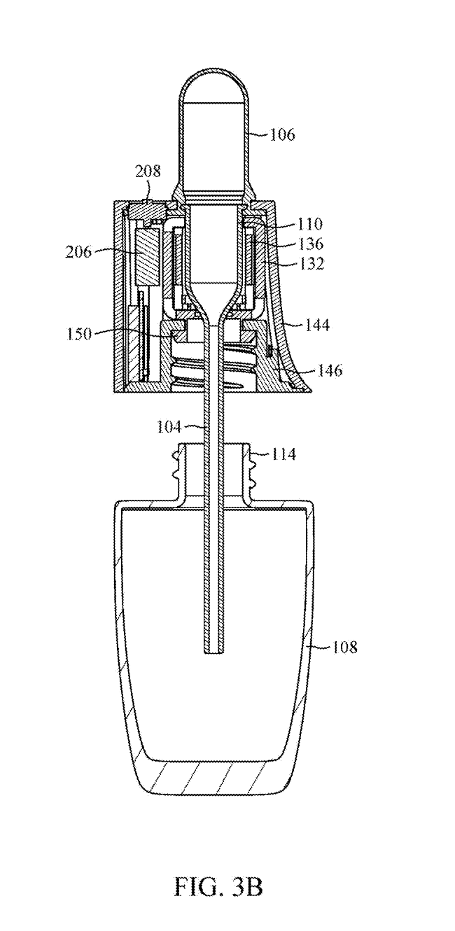

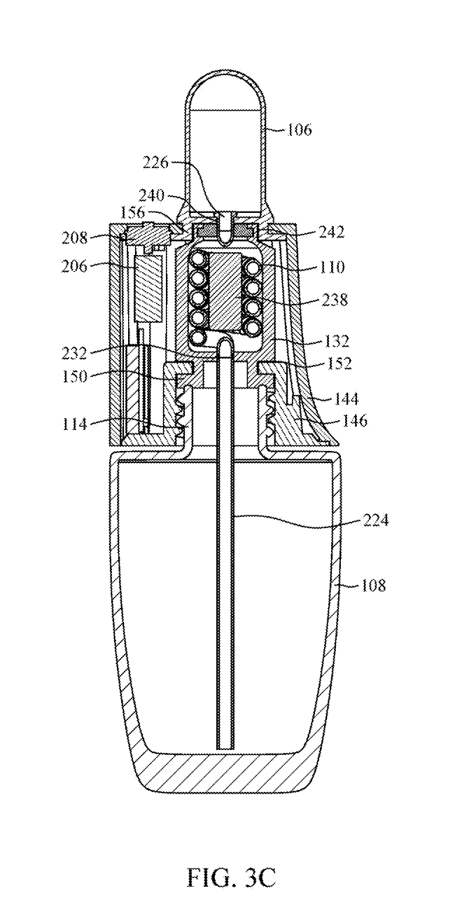

In an embodiment, a stop-flow vent valve is disposed within the functional cap to address the influence of residual liquid within the liquid guide tube 104. Referring to FIGS. 3A, 4A, and 5 to 6C, the stop-flow vent valve 116 is arranged between the heating chamber 110 and the liquid guide tube 104. The stop-flow vent valve 116 is configured to regulate airflow and liquid flow during different operational stages.

The stop-flow vent valve 116 includes a valve body 118 and a valve core 120. The valve body 118 defines a main flow chamber 122 and a bypass chamber 124. One end of the main flow chamber 122 is fluidly connected to the heating chamber 110, and the opposite end of the main flow chamber 122 is fluidly connected to the liquid guide tube 104. A first vent 126 is formed between the bypass chamber 124 and the main flow chamber 122, and a second vent 128 is formed on a side of the bypass chamber 124 remote from the first vent 126.

The valve core 120 is movably arranged within the bypass chamber 124 and is configured to move between a first position, a second position, and a third position in response to operation of the liquid suction and discharge component 106. In the first position, the valve core 120 blocks the first vent 126. In the second position, the valve core 120 opens both the first vent 126 and the second vent 128. In the third position, the valve core 120 blocks the second vent 128.

The valve core 120 is a lightweight valve ball or a similar movable sealing element. Through coordinated movement of the valve core 120 within the bypass chamber 124, different airflow paths and liquid flow states are selectively established during skincare liquid extraction, extraction stopping, and liquid discharge stages. As a result, the stop-flow vent valve 116 enables precise control of liquid flow and air pressure balance, thereby improving the accuracy of liquid dosing, enhancing heating efficiency, and reducing the thermal influence of residual liquid in the liquid guide tube 104.

The stop-flow vent valve 116 cooperates with the heating assembly 102 and the liquid suction and discharge component 106 to ensure stable, efficient, and repeatable heating and dispensing of skincare liquids.

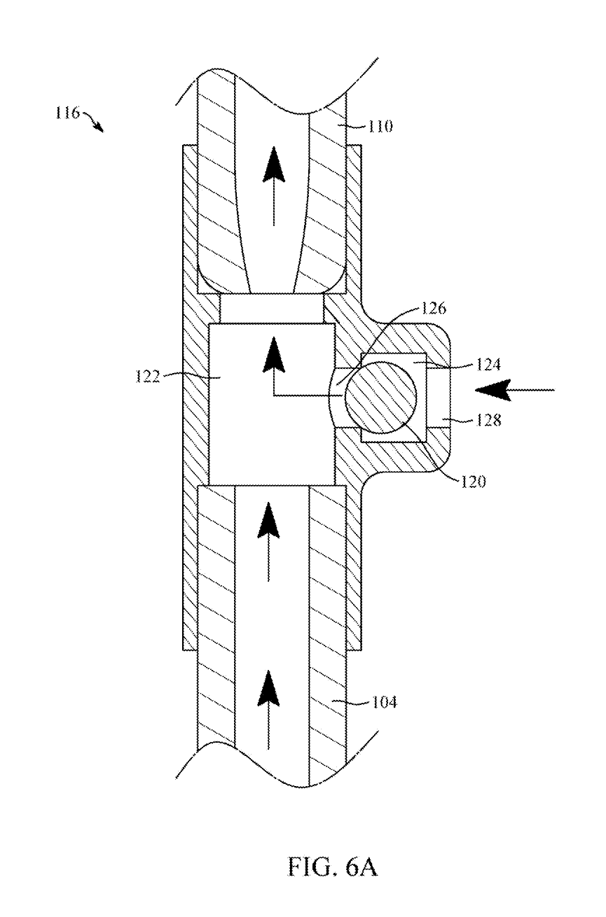

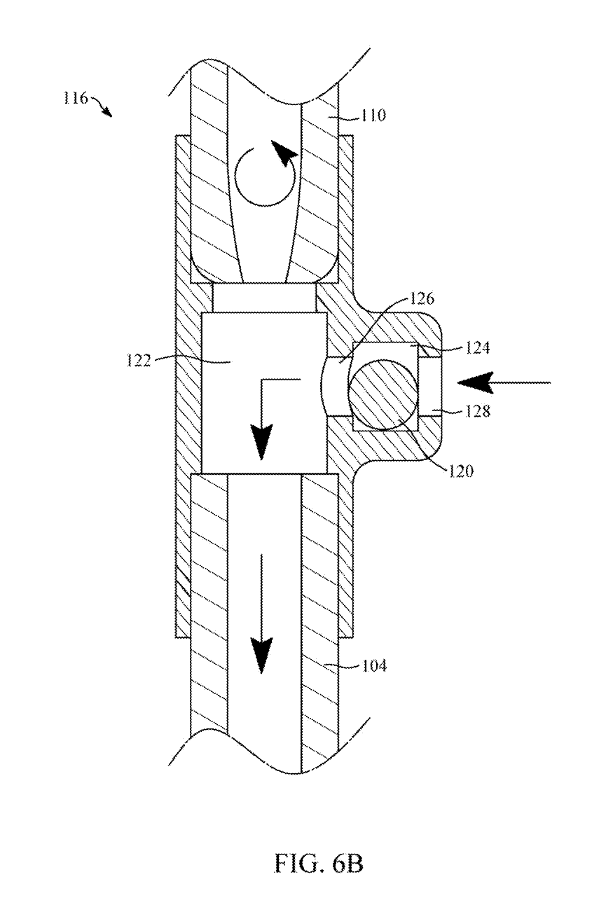

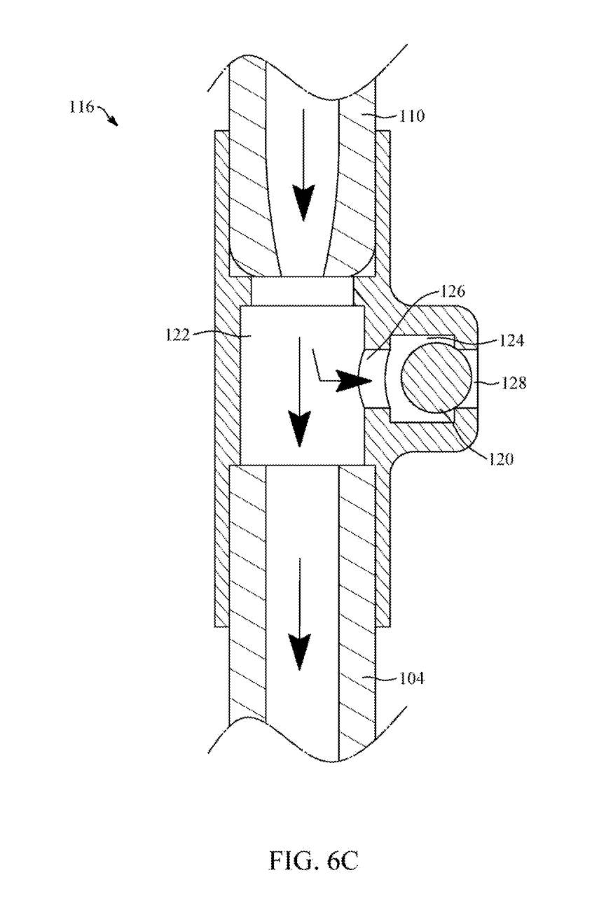

Referring to FIG. 6A, shows a skincare product extraction stage of the stop-flow vent valve 116. During the skincare product extraction stage, the liquid suction and discharge component 106 is actuated to generate a negative pressure within the heating chamber 110, thereby drawing the skincare product from the bottle body 108 into the heating chamber 110 through the liquid guide tube 104. As the skincare product is introduced into the heating chamber 110, the internal air pressure within the heating chamber 110 decreases. Under the action of this pressure difference, the valve core 120 is driven to move to the first position, in which the valve core 120 seals the first vent 126, thereby preventing external air from entering the heating chamber 110. This configuration ensures stable negative pressure within the heating chamber 110 and enables the skincare product to be smoothly and reliably drawn into the heating chamber 110.

Referring to FIG. 6B, shows an extraction stopping stage of the stop-flow vent valve 116. When the heating chamber 110 has received a predetermined amount of skincare product, the liquid suction and discharge component 106 stops operating, thereby terminating the extraction process. At this stage, since no additional pressure force is applied to the valve core 120, the valve core 120 automatically moves downward to the second position under gravity or elastic restoring force. In this position, the first vent 126 and the second vent 128 are fluidly communicated, allowing air to flow through opposite ends of the liquid guide tube 104 and breaking the pressure balance within the tube.

As a result, residual skincare product remaining in the liquid guide tube 104 is discharged automatically under the action of gravity. Meanwhile, the skincare product stored within the heating chamber 110 does not flow out, since the air pressure within the heating chamber 110 remains substantially unchanged. Accordingly, the skincare product remains confined within the heating chamber 110 for subsequent heating.

Referring to FIG. 6C, shows a skincare product discharge stage of the stop-flow vent valve 116. After the skincare product within the heating chamber 110 has been heated to a desired temperature, the liquid suction and discharge component 106 is actuated again, this time to apply a positive pressure for discharging the heated skincare product. Under the influence of air pressure, the valve core 120 moves to the third position, in which the second vent 128 is blocked. In this configuration, the airflow path is controlled such that the heated skincare product can be smoothly discharged from the heating chamber 110 through the liquid guide tube 104 for user application.

Through coordinated switching of the valve core 120 among the first, second, and third positions, the stop-flow vent valve 116 enables different airflow and liquid flow states corresponding to the extraction stage, extraction stopping stage, and discharge stage, respectively. As a result, residual skincare product within the liquid guide tube 104 can be effectively discharged, leaving only the skincare product required for use within the heating chamber 110 for heating. This design improves heating accuracy, reduces user waiting time, simplifies operational steps, and enhances overall usability and user experience.

In an embodiment, the stop-flow vent valve is configured to permit skincare liquid to pass from the bottle body into the heating chamber during an extraction stage and to facilitate return of residual skincare liquid present in the liquid guide tube back into the bottle body during a pressure equalization stage, thereby ensuring that only a predetermined quantity of skincare liquid remains stored within the heating chamber.

The predetermined quantity retained within the heating chamber corresponds substantially to the internal volume of the heating chamber and is defined by the coordinated interaction between the liquid suction and discharge component and the valve mechanism. By preventing excess liquid retention within the liquid guide tube and controlling air communication, the valve mechanism enables metered storage of skincare liquid within the heating chamber.

Although the foregoing embodiments describe a stop-flow vent valve including a valve body and a movable valve core having multiple switching positions, the present invention is not limited to this specific structural configuration. The valve mechanism may comprise any pressure-responsive or flow-control structure capable of allowing forward liquid flow during extraction and enabling residual liquid return or pressure equalization after extraction.

In alternate embodiments, the valve mechanism may comprise a non-return valve (NRV), check valve, one-way valve, duckbill valve, diaphragm valve, spring-loaded valve, gravity-biased valve, solenoid valve, or a combination of multiple valve elements arranged to achieve equivalent functional control of liquid and air flow.

In an exemplary embodiment, when the stop-flow vent valve 116 is a non-return valve assembly, hereinafter referred to as an NRV valve 116, which includes a valve body 118 and a one-way valve element or valve core 120. The valve body 118 defines a main flow chamber 122 extending along a longitudinal direction. One end of the main flow chamber 122 is fluidly connected to the heating chamber 110, and an opposite end of the main flow chamber 122 is fluidly connected to the liquid guide tube 104

The one-way valve element or valve core 120 is movably arranged within the main flow chamber 122 and is configured to permit fluid flow only in a first direction from the liquid guide tube 104 to the heating chamber 110 while preventing reverse flow in an opposite direction. The one-way valve element or Valve core 120 may be implemented as a valve ball, a spring-biased sealing member, a flexible diaphragm, or any equivalent check valve structure.

The metering function may be achieved by a coordinated arrangement of multiple one-way valves, pressure relief ports, or air vents configured to create controlled pressure differentials during extraction and discharge stages, thereby ensuring that only a desired or predetermined volume of skincare liquid is retained within the heating chamber.

As used herein “stop-flow vent valve” broadly encompasses any flow-regulating structure configured to (i) permit intake of skincare liquid into the heating chamber, (ii) prevent unintended backflow during discharge, and (iii) enable residual liquid in the liquid guide tube to return to the bottle body or otherwise be removed so that a metered volume remains within the heating chamber.

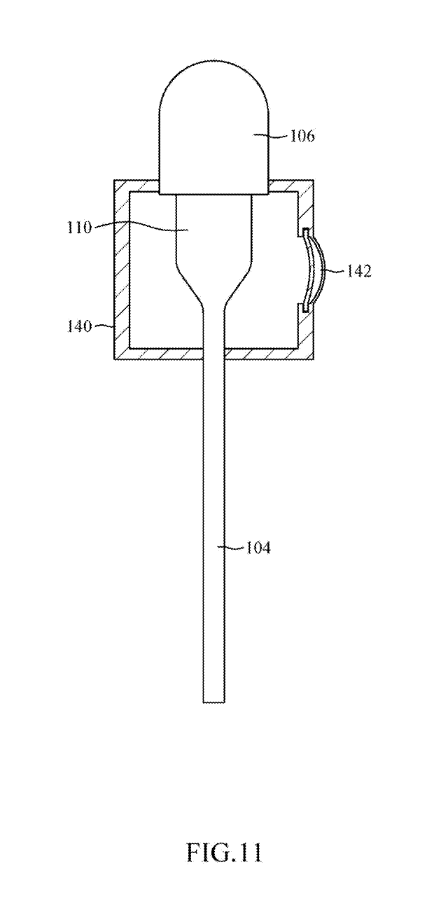

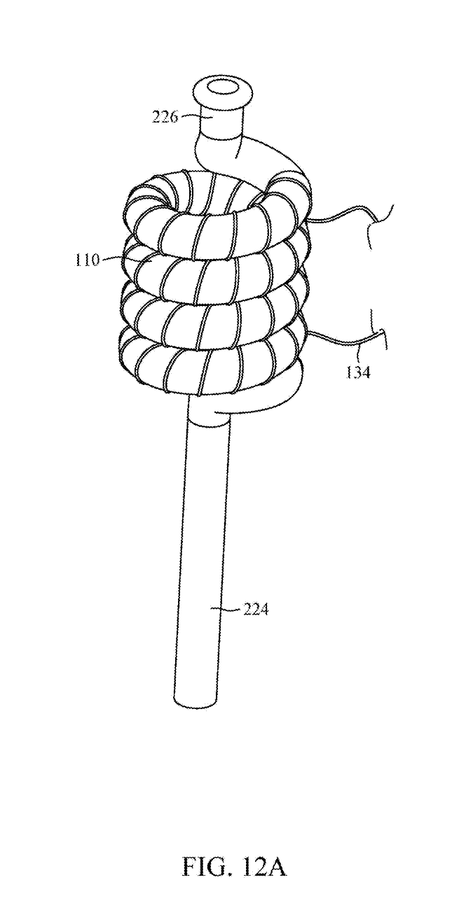

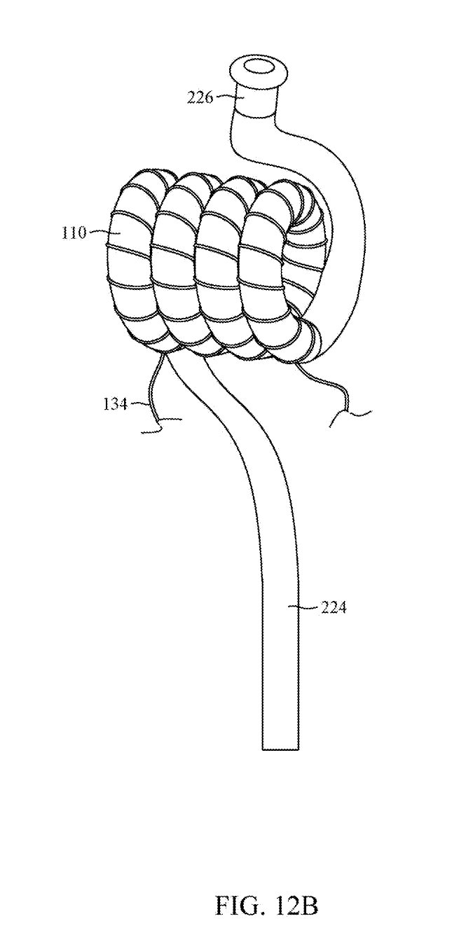

FIGS. 3C shows the spiral-shaped heating chamber 110 extending in a substantially vertical direction, and FIG. 12A shows the spiral-shaped heating chamber 110 extending in a substantially horizontal direction. These configurations increase the effective heat exchange surface area and residence time of the liquid, and may be selectively adjusted according to design requirements.

The heating assembly 102 comprises the heating element 134 arranged on or in close thermal contact with the spiral-shaped heating chamber 110. The heating element 134 is configured to generate heat and transfer the heat directly to the heating chamber 110, thereby efficiently heating the skincare product flowing within the liquid guide tube 104.

During use, the user operates the liquid suction and discharge component 106 to draw the skincare product from the bottle body 108 into the heating chamber 110 of the liquid guide tube 104. The heating element 134 is then activated to heat the spiral-shaped heating chamber 110. Due to the spiral configuration, the contact area between the liquid and the heated surface is significantly increased, allowing uniform and rapid heat transfer to the skincare product. Once a desired temperature is reached, the user again operates the liquid suction and discharge component 106 to discharge the heated skincare product from the liquid guide tube 104 for application.

By heating only the skincare product required for immediate use, repeated heating of the entire contents within the bottle body 108 is avoided, thereby preventing degradation, loss of efficacy, or deterioration of heat-sensitive ingredients. Additionally, this configuration reduces energy consumption and waiting time while improving product freshness, absorption efficiency, and overall user experience.

Accordingly, the heated cap enables instantaneous and localized heating of skincare products, enhances functional performance, simplifies operation, and provides a safe, efficient, and user-friendly solution for skincare product application.

Referring to FIGS. 4C, 12A, and 12B, the heating element 134 is wound around the heating chamber 110 of the liquid guide tube. The heating element 134 can be implemented in various forms, including but not limited to heating wires, heating sheets, or heating rods, which may be selected according to different application scenarios, heating requirements, or product specifications. The winding density, pitch, and arrangement of the heating element 134 may be correspondingly adjusted to optimize heating efficiency and temperature uniformity.

By winding the heating element 134 along the spiral-shaped heating chamber 110, the heating chamber 110 is effectively divided into multiple heating segments along its length. Each segment is capable of independently transferring heat to the skincare product flowing therethrough, thereby enabling rapid and uniform heating of the skincare product and ensuring temperature consistency throughout the entire liquid flow path.

The spiral-shaped heating chamber improves heating speed and heating uniformity, and also enhances overall operational efficiency, thereby providing users with a more convenient, efficient, and comfortable skincare experience.

Referring to FIGS. 4A to 4C, the heating assembly 102 further comprises a temperature sensor 228 and a circuit board 210. The temperature sensor 228 is arranged on the heating chamber 110 of the liquid guide tube 104, and the circuit board 210 is disposed within the cap body 100. The circuit board 210 is electrically connected to the temperature sensor 228 and the heating element 134 and is configured to control the operating state and heating temperature of the heating element 134.

In an embodiment, the temperature sensor 228 is configured to monitor, in real time, the temperature of the skincare product within the liquid guide tube 104. The temperature sensor 228 provides accurate temperature feedback to the circuit board 210, enabling the heating temperature to be maintained within a preset safe range, for example, between 36 °C and 40 °C, thereby ensuring suitability for skin application.

The circuit board 210 may be fixed inside the cap body 100 by a mounting bracket 216 and is configured to manage and regulate the entire heating process. When the temperature sensor 228 detects that the temperature of the skincare product has reached or exceeded a preset target value, the circuit board 210 automatically reduces or interrupts power supplied to the heating element 134 to prevent overheating. Conversely, when the detected temperature falls below the preset value, the circuit board 210 resumes heating operation to maintain a stable temperature.

Through this closed-loop temperature control mechanism, degradation or loss of activity of heat-sensitive ingredients in essential oils or other skincare products caused by excessive heating is effectively prevented. At the same time, the risk of skin burns during use is significantly reduced, thereby improving overall product safety.

Furthermore, the combination of rapid, uniform, and low-temperature heating allows users to quickly obtain warmed skincare products suitable for enhanced skin absorption, reducing waiting time and improving user convenience. The intelligent temperature-controlled heating structure also minimizes unnecessary energy consumption while ensuring effective heating, thereby improving the energy efficiency and environmental friendliness of the device.

Accordingly, by incorporating the temperature sensor 228 and the circuit board 210, precise and reliable temperature control for heated skincare products is provided, and also delivers a safe, efficient, and user-friendly skincare solution.

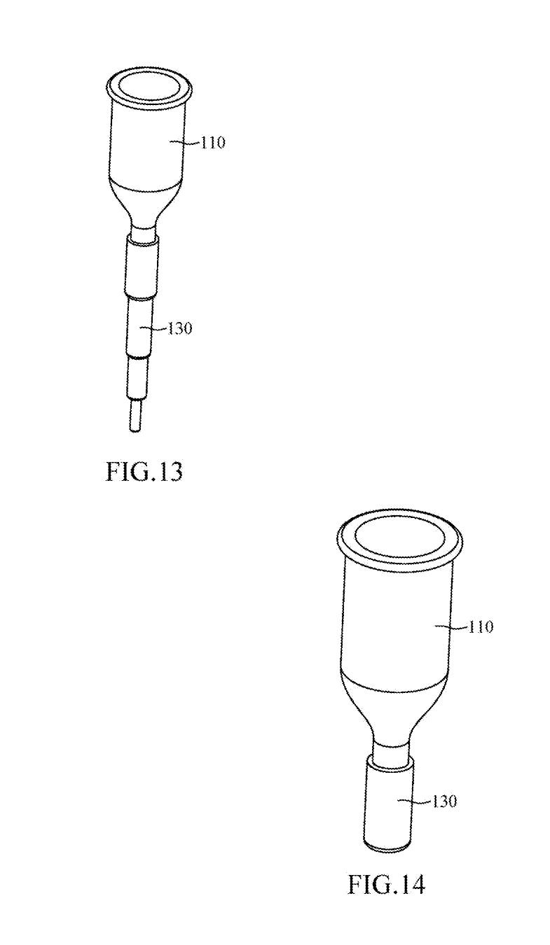

Referring to FIGS. 13 and 14, in an embodiment, the liquid guide tube 104 includes a plurality of tube segments 130 that are sequentially connected and configured to extend or retract relative to one another.

Specifically, the liquid guide tube 104 is formed as a telescopic structure comprising multiple tube segments 130, each of which is slidably engaged with the adjacent tube segment 130. This configuration allows the liquid guide tube 104 to retract into a compact state when not in use or when residual liquid needs to be removed, and to extend to a required length during the extraction of skincare products.

In use, when skincare products are to be extracted, the liquid guide tube 104 is extended to its full length. Before heating, the liquid guide tube 104 may be retracted to its shortest state. As the tube retracts, the internal volume of the liquid guide tube 104 is reduced, thereby forcing any residual skincare product within the tube to flow out. This effectively prevents residual skincare product from affecting the temperature of the skincare product stored in the heating chamber 110.

Accordingly, the telescopic arrangement of the liquid guide tube 104 allows residual skincare product to be rapidly cleared, ensuring that only the skincare product within the heating chamber 110 is heated. This guarantees consistent temperature control during each use. Furthermore, when retracted, the liquid guide tube 104 occupies less space, rendering the functional cap structure more compact and convenient for storage and portability.

Referring to FIGS. 4A and 4B, the cross-sectional area relationship between the liquid guide tube 104 and the heating chamber 110 is disclosed. The cross-sectional area of the liquid guide tube 104 is smaller than the cross-sectional area of the heating chamber 110. The heating chamber 110 defines a primary space for storing and heating skincare products. Its relatively large cross-sectional area allows it to accommodate a sufficient volume of skincare product and promotes uniform heat distribution. In contrast, the liquid guide tube 104 has a smaller cross-sectional area, which facilitates faster liquid flow during extraction and discharge, thereby improving operational efficiency.

Additionally, the reduced cross-sectional area of the liquid guide tube 104 minimizes the amount of skincare product retained therein, improving hygiene, freshness, and ease of cleaning. When a skincare product enters the heating chamber 110 from the liquid guide tube 104, the product rapidly disperses into the larger chamber space, enabling faster and more uniform heat transfer and thereby enhancing heating efficiency.

Through this configuration, the functional cap optimizes both liquid flow and thermal performance while enhancing compactness and cleanliness of the device.

Referring to FIGS. 3A, 3B, 4A, and 4B, the heating assembly 102 comprises a heat insulation box 132 and the heating element 134. The heat insulation box 132 surrounds the heating chamber 110, and the through holes are formed at opposite ends of the heat insulation box 132 to allow the heating chamber 110 to pass through. The heating element 134 is disposed between the heating chamber 110 and the heat insulation box 132.

Specifically, the heat insulation box 132 is arranged outside the heating chamber 110 to thermally isolate the heating chamber 110 from the external environment. The through holes are provided at the upper and lower ends of the heat insulation box 132, which enable fluid communication between the heating chamber 110, the liquid guide tube 104, and the liquid suction and discharge component 106, ensuring unobstructed liquid flow. The heat insulation box 132 may be formed from materials having favorable thermal insulation properties, such as foam plastics or fiberglass, to reduce heat loss.

The heating element 134 is arranged in a space between the heating chamber 110 and the heat insulation box 132 and is configured to directly heat the heating chamber 110. The heating element 134 may take various forms.

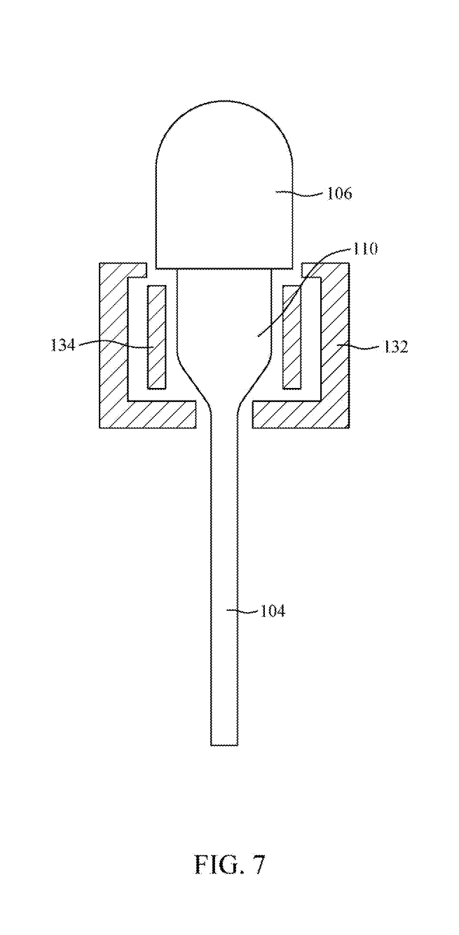

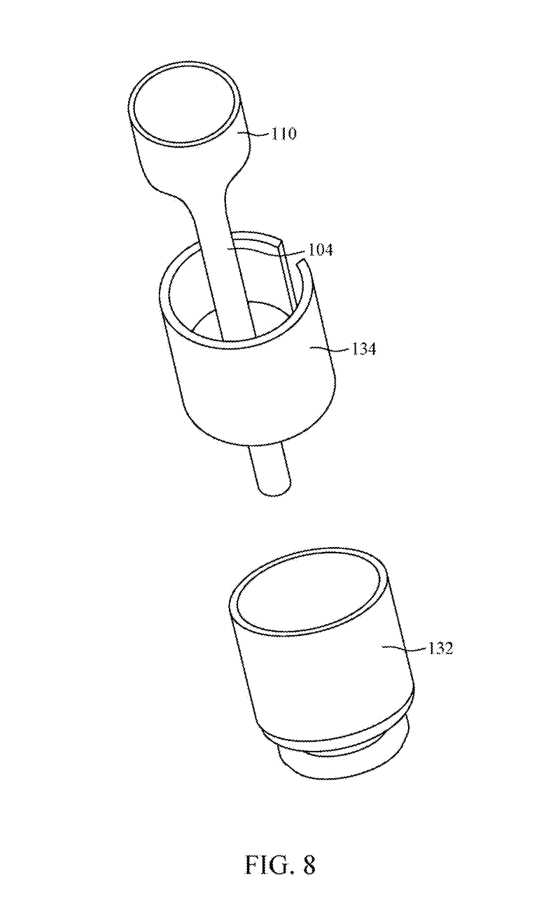

For example, as shown in FIG. 7, the heating element 134 may be a rigid heating plate, such as a ceramic heating plate, mica heating plate, or PTC heating plate. As shown in FIG. 8, the heating element 134 can alternatively be a flexible heating element, such as a graphene heating film, silicone rubber heating plate, or polyimide heating film. As shown in FIG. 9, the heating element 134 may further be implemented as an alumina heating ceramic tube.

During a heating process, the heating element 134 is energized to rapidly transfer heat to the skincare product within the heating chamber 110. Due to the insulating effect of the heat insulation box 132, heat loss is minimized, enabling the skincare product to reach a target temperature within a short period of time. After the skincare product reaches the desired temperature, the heating element 134 may reduce power output or stop operating, while the heat insulation box 132 continues to retain heat and maintain the skincare product within a stable temperature range until use.

Accordingly, by combining the heating element 134 with the heat insulation box 132, the functional cap achieves rapid heating, reduced heat loss, improved temperature stability, and shortened user waiting time, thereby overcoming deficiencies associated with conventional heating structures.

Referring to FIGS. 3C and 4C, the functional cap further comprises a heat insulation assembly 230 disposed within the cap body 100. The heat insulation assembly 230 is arranged around or adjacent to the heating chamber 110 and is configured to reduce heat loss therefrom.

The heat insulation assembly 230 may be formed from materials having low thermal conductivity and good thermal insulation properties, including but not limited to foam plastics, silicone-based materials, or aerogel materials. Such materials effectively inhibit heat exchange between the heating chamber 110 and the external environment.

By reducing heat dissipation, the heat insulation assembly 230 enables the heating element 134 to more efficiently transfer thermal energy to the skincare product flowing within the heating chamber 110, thereby shortening heating time and improving heating efficiency. Additionally, the heat insulation assembly 230 assists in maintaining the temperature of the heating chamber 110 for a period of time after active heating is stopped, allowing users to continuously obtain a warmed skincare product without frequent reheating.

Accordingly, by introducing the heat insulation assembly 230, the functional cap effectively enhances heating efficiency, temperature stability, and energy utilization, thereby further improving user experience and operational performance of the functional cap.

In an embodiment, the heat insulation assembly 230 comprises the heat insulation box 132. The heating chamber 110 of the liquid guide tube 104 is disposed within the heat insulation box 132. A first through hole 232 is formed at a bottom portion of the heat insulation box 132, and a second through hole 234 is formed at a top portion of the heat insulation box 132. The first end 224 of the liquid guide tube 104 passes through the first through hole 232, and the second end 226 of the liquid guide tube 104 passes through the second through hole 234.

In an embodiment, the heat insulation box 132 further includes a heat insulation cover 236 arranged at a top opening thereof. The heat insulation cover 236 is configured to be selectively opened and closed to facilitate assembly, maintenance, or replacement of the heating chamber 110 of the liquid guide tube 104. The first through hole 232 at the bottom of the heat insulation box 132 allows the first end 224 of the liquid guide tube 104 to extend into the bottle body 108, thereby enabling the liquid guide tube 104 to draw skincare product from the bottle body 108 while maintaining sealing and thermal isolation of the heat insulation box 132.

The second through hole 234 formed in the heat insulation cover 236 allows the second end 226 of the liquid guide tube 104 to be connected to the liquid suction and discharge component 106, thereby enabling user-controlled intake and discharge of the skincare product while preserving the closed and insulated state of the heat insulation box 132.

The heating chamber 110 is fully received within the heat insulation box 132 and is surrounded by thermally insulating material, thereby reducing heat transfer to the external environment. It is to be understood that, since the heating element 134 and the temperature sensor 228 are disposed on the heating chamber 110, the heating element 134 and the temperature sensor 228 are likewise accommodated within the heat insulation box 132.

By utilizing the internal space of the cap body 100, the heat insulation box 132 enables a compact, orderly arrangement of the heating chamber 110, the heating element 134, and the temperature sensor 228, thereby improving overall structural compactness and integration of the heating cap.

Referring to FIGS. 3C and 4C, the heat insulation assembly 230 further comprises at least one heat insulation column 238 disposed within a central region of the spiral-shaped heating chamber 110.

In an embodiment, the heat insulation column 238 may be formed from materials having excellent thermal insulation properties, including but not limited to silicone, aerogel, or foam plastics. Such materials exhibit low thermal conductivity, thereby significantly reducing outward heat conduction and enhancing thermal retention efficiency.

The heat insulation column 238 is arranged to fill internal gaps or hollow regions defined by the spiral configuration of the heating chamber 110, thereby reducing air gaps that would otherwise contribute to heat loss. Through this configuration, thermal energy generated by the heating element 134 is more effectively concentrated within the heating chamber 110 and transferred to the skincare product flowing therein, resulting in reduced heating time and improved heating efficiency.

Accordingly, by incorporating the heat insulation box 132 and the heat insulation column 238, the functional cap provides enhanced heat preservation and efficient heating performance, ensuring that skincare products can be rapidly heated to a suitable temperature for use while maintaining energy efficiency and user convenience.

Referring to FIGS. 3A, 3B, 4A, and 4B, the heating element 134 further comprises a heat-conducting seat 136 disposed within the heat insulation box 132. The heat-conducting seat 136 is sleeved around the heating chamber 110, and a heating element 134 is mounted on the heat-conducting seat 136. The heat-conducting seat 136 is configured as a hollow heat-conducting structure having openings at opposite ends and fitted onto an outer surface of the heating chamber 110, such that heat can be uniformly transferred to the heating chamber 110 while simultaneously providing mechanical support and protection. The heat-conducting seat 136 further serves to stably secure the heating element 134, thereby improving structural reliability.

In an embodiment, the heat-conducting seat 136 is made of a ceramic material. Ceramic materials provide excellent thermal conductivity and thermal stability, are resistant to deformation at elevated temperatures, and exhibit insulating properties that reduce electrical safety risks. Additionally, ceramic materials exhibit strong chemical resistance, making them suitable for prolonged contact with various skincare products.

Referring to FIGS. 4A, 4B, 10, and 11, the heating element 134 may be implemented as a heat-conducting rod mounted on the heat-conducting seat 136 or as a heating wire wound around the heat-conducting seat 136, thereby enabling uniform temperature distribution within the heating chamber 110.

During operation, when the heating element 134 is energized, the heat generated by the heating element 134 is first absorbed by the heat-conducting seat 136 and is then rapidly and evenly transferred to the heating chamber 110 and the skincare product contained therein. After the heating element 134 is deactivated or its power is reduced, the heat-conducting seat 136 retains a portion of the thermal energy and continues to transfer heat to the heating chamber 110, thereby maintaining the skincare product within a relatively stable temperature range. Through this configuration, heating efficiency and temperature uniformity are further improved, enhancing overall user experience.

Referring to FIGS. 4A and 4B, the heating element 134 further includes a thermally conductive structure layer 138 disposed between the heat-conducting seat 136 and the heating chamber 110. The thermally conductive structure layer 138 fills gaps between the heat-conducting seat 136 and the heating chamber 110 so as to improve thermal contact therebetween. The thermally conductive structure layer 138 may be implemented as thermal paste, thermal pads, thermal adhesive tapes, or other suitable thermally conductive materials. By filling microscopic gaps and reducing thermal resistance, the thermally conductive structure layer 138 significantly improves heat transfer efficiency from the heat-conducting seat 136 to the heating chamber 110.

Referring to FIGS. 11, the heating element 134 includes a housing 140 and a metal spring 142. The housing 140 surrounds the heating chamber 110 and contains a supersaturated solution, such as a sodium acetate solution, which remains in a liquid supersaturated state at room temperature. The metal spring 142 is disposed on the housing 140, and a corresponding actuating button may be provided on the cap body 100 at a position corresponding to the metal spring 142. When the user presses the actuating button, the metal spring 142 is deformed, thereby triggering crystallization of the supersaturated solution within the housing 140. Upon triggering, the supersaturated liquid undergoes a rapid phase change from the metastable liquid state to a solid crystalline state. This phase transition is an exothermic process in which the latent heat of crystallization is released as the dissolved solute molecules arrange into an ordered solid lattice structure.

The released heat is transferred through the housing 140 to the surrounding heating chamber 110, thereby rapidly increasing the temperature of the heating chamber 110 and the skincare product contained therein. Because the heat generation results from an internal chemical phase change rather than electrical resistance heating, the mechanism provides immediate thermal output without requiring an external power supply or battery. This heating mechanism operates similarly to that of a reusable hand warmer and enables instant heating in a controlled and energy-efficient manner, thereby simplifying operation, reducing energy consumption, and lowering manufacturing cost.

Referring to FIGS. 1A to 4C, the bottle body 108 is provided with the bottle mouth portion 114. The cap body 100 comprises an outer shell 144 and a base 146. The liquid suction and discharge component 106 is disposed at a top portion of the outer shell 144, and a connection port is formed at a bottom portion of the outer shell 144. The base 146 is connected to the connection port and is configured to surround and connect to the bottle mouth portion 114. The heating assembly 102 is arranged between the outer shell 144 and the base 146, and the liquid guide tube 104 is disposed adjacent to the base 146. Through this arrangement, the heating assembly 102 is accommodated within a confined space formed between the outer shell 144 and the base 146, thereby achieving heating while maintaining a compact overall structure.

Referring to FIGS. 3A, 3B, 4A, and 4B, a connecting hole 148 is formed at the top portion of the base 146. A bottom portion of the heat insulation box 132 is provided with an annular sealing part 150, and a connecting groove 152 is formed between the sealing part 150 and the heat insulation box 132. An edge of the connecting hole 148 is embedded into the connecting groove 152, such that the heat insulation box 132 is firmly fixed on the base 146. The sealing part 150 is sandwiched between the top of the base 146 and an end face of the bottle mouth portion 114, thereby sealing a connection between the functional cap and the bottle body 108. The sealing part 150 may be formed of elastic materials such as silicone or rubber to ensure long-term sealing reliability, prevent leakage of skincare products, and block external contaminants.

Referring to FIGS. 4C, in an embodiment, an edge portion of the base 146 is provided with at least one connecting post 248. The circuit board 210 is mounted on the mounting bracket 216, and the mounting bracket 216 is provided with a connecting portion 250 corresponding to the connecting post 248. The connecting portion 250 is fixed to the connecting post 248 by fasteners such as screws, thereby securely mounting the circuit board 210 on the base 146.

The sealing part may be made of a material with good elasticity and durability, such as silicone or rubber, to ensure a sealing effect and reliability during long-term use. The sealing part effectively fills the gap between the top of the base and the bottle mouth, preventing skincare liquids from leaking or external contaminants from entering the bottle body.

Referring to FIGS. 1A, 2, 3B, and 4B, the liquid suction and discharge component 106 includes a pressing cap disposed on the cap body 100 and fluidly connected to the heating chamber 110. A mounting hole 154 is formed at the top of the outer shell 144, and a mounting part 156 is formed at the bottom portion of the pressing cap and received within the mounting hole 154 to fix the pressing cap in position.

Referring to FIGS. 4B, 13 and 14, in an exemplary embodiment, the pressing cap is implemented as a dropper cap or as an elastic telescopic cap. By pressing the pressing cap, negative pressure is generated to draw skincare product from the bottle body 108 into the heating chamber 110 through the liquid guide tube 104. After heating, pressing the pressing cap again discharges the heated skincare product for use, thereby simplifying user operation.

Referring to FIGS. 1A, 1B, 2, 3C, and 4C, in an embodiment, the mounting hole 154 is formed at the top of the outer shell 144. The liquid suction and discharge component 106 is implemented as a dropper cap, which is mounted within the mounting hole 154 and positioned above the heat insulation box 132. A third through hole 240 is formed at the bottom portion of the dropper cap and is aligned with and in fluid communication with the second through hole 234 formed in the heat insulation box 132. The second end 226 of the liquid guide tube 104 passes through the second through hole 234 and the third through hole 240 and is fluidly connected to the dropper cap.

In an embodiment, the liquid guide tube 104 functions as a liquid conduit for guiding the skincare product and may be implemented as a flexible tube commonly used in dropper-type dispensing structures. The mounting hole 154 provides a fixed installation position for the dropper cap, thereby ensuring stable mounting, reliable sealing, and convenient user operation.

In an embodiment, the liquid guide tube may be a one-piece molded structure, which is convenient for processing and improves the overall structural strength and sealing performance. The first end of the liquid guide tube is inserted into the bottle body to draw up the skincare liquid inside the bottle body. The second end of the liquid guide tube is exposed on the cap body and is equipped with the liquid suction and discharge component for user operation.

The dropper cap may be formed from elastic and durable materials, such as silicone or soft plastic, to ensure shape recovery after repeated squeezing operations. When the user squeezes the dropper cap, the internal volume thereof is reduced, causing air contained therein to be expelled. Upon release of the squeezing force, the dropper cap elastically returns to its original shape, thereby increasing its internal volume and generating negative pressure. Under the action of the negative pressure, the skincare product stored in the bottle body 108 is drawn into the liquid guide tube 104 until pressure equilibrium is achieved. When the dropper cap is squeezed again, the internal volume decreases once more, thereby expelling the skincare product from the liquid guide tube 104 for dispensing.

In an exemplary embodiment, the liquid suction and discharge assembly may be implemented as a dropper cap. When a user first squeezes the dropper cap, the internal volume decreases and air is expelled. After releasing the pressure, the dropper cap returns to its original shape, and the internal volume increases, creating negative pressure lower than the external atmospheric pressure. Under this negative pressure, the skincare liquid in the bottle body is drawn into the liquid guide tube until the internal and external pressures are balanced. When the user squeezes the dropper cap again, the internal volume decreases, and the skincare liquid in the liquid guide tube is expelled due to the pressure. This design allows users to complete the intake and discharge of skincare liquids with simple squeezing actions without complicated operating steps.

In an exemplary embodiment, referring to FIGS. 1A to 3B, 4A and 4B, the liquid suction and discharge component 106 includes a push-pull rod 158 and a piston 160. The piston 160 is slidably disposed within the heating chamber 110, and the push-pull rod 158 is connected to the piston 160 and extends through the cap body 100. The push-pull rod 158 passes through a mounting part 156 that guides and limits the movement of the push-pull rod 158 while sealing the heating chamber 110. When the push-pull rod 158 is pulled outward, the piston 160 moves backward to generate negative pressure, drawing the skincare product into the heating chamber 110. When the push-pull rod 158 is pushed inward, the piston 160 moves forward to discharge the heated skincare product, thereby enabling precise control of dosage.

Referring to FIGS. 4A and 4B, the functional cap further includes an electronic control component 200 disposed on the cap body 100 for controlling the operation of the functional cap.

In an embodiment, a mounting part 156 is provided with a fixing hole 202, and a top portion of the outer shell 144 is provided with a positioning hole 204 that corresponds to and communicates with the fixing hole 202. The electronic control component 200 includes a battery 206, a power management module 208, and the circuit board 210. The battery 206 is disposed within the cap body 100. The power management module 208 includes a button 212 and a charging component 214, wherein the button 212 is disposed within the fixing hole 202 and exposed through the positioning hole 204, and the charging component 214 is arranged on the button 212. The circuit board 210 is disposed within the cap body 100 and is electrically connected to the heating element 134, the battery 206, the button 212, and the charging component 214.

Specifically, the fixing hole 202 formed in the mounting part 156 is configured to mount and secure the power management module 208. The positioning hole 204 formed in the outer shell 144 aligns with and communicates with the fixing hole 202, such that the button 212 is exposed on an outer surface of the outer shell 144 for user operation and charging access. The power management module 208 integrates the button 212 and the charging component 214 into a single assembly, thereby reducing occupied space and improving compactness of the overall structure. The charging component 214 may be implemented as a charging interface, charging head, charging electrode, or other suitable charging structure.

The battery 206 supplies power to the device, and the circuit board 210 is fixed to the base 146 by the mounting bracket 216 and is configured to coordinate and control the operation of the various functional modules. By pressing the button 212, the user can control the operation of the heating element 134, such as turning the heating element on or off or adjusting heating power. The battery 206 may be recharged through the charging component 214.

Accordingly, the above-described embodiments achieve compact installation of the electronic control component 200, enable intelligent control and power management, simplify user operation, and ensure convenient, stable, and efficient operation of the device.

In an embodiment, the circuit board may be fixed inside the cap body by a bracket. The edge of the base is provided with a connecting column, and the bracket is provided with a connecting part corresponding to the connecting column. The connecting part can be connected to the connecting column by fasteners such as screws, thereby stably installing the circuit board on the base.

In an embodiment, the top of the outer shell is provided with a positioning hole. The bottom of the pressing cap or dropper cap is provided with a mounting part located inside the outer shell. The mounting part is snapped into a mounting hole at the top of the outer shell. The mounting part is provided with a limiting groove for limiting the top of the insulation box. The mounting part is also provided with a fixing hole corresponding to the positioning hole, wherein the fixing hole is used to fix the power management module. The positioning hole exposes the power management module for user touch control and charging.

Referring to FIG. 3C, the mounting part 156 is further provided with a limiting groove 242 configured to limit and stabilize the top portion of the heat insulation box 132. In addition, the mounting part 156 includes the fixing hole 202 corresponding to the positioning hole 204, the fixing hole 202 being configured to mount and secure the power management module 208. The positioning hole 204 allows the power management module 208 to be exposed for user operation and charging access.

Referring to FIGS. 3C and 4C, in an embodiment, the functional cap further comprises the battery 206 and the power management module 208. The battery 206 is disposed within the cap body 100 and is electrically connected to the circuit board 210, thereby providing electrical power to the heating assembly 102 and associated control components. The power management module 208 is arranged on the cap body 100 and is electrically connected to the circuit board 210, and is configured to control power activation, deactivation, and charging operations of the functional cap.

In an embodiment, the battery 206 may be selected from various rechargeable battery types, such as lithium-based batteries or nickel-metal hydride batteries, to ensure portability, sufficient operating duration, stable output, and efficient charging performance of the device.

In an embodiment, the battery may be a lithium battery or a nickel-metal hydride battery, selected to ensure the device's portability, battery life, and charging efficiency. The battery provides the necessary power support for the entire heating structure and electronic control components.

Additionally, in an embodiment, the button 212 can be electrically connected to the liquid suction and discharge component 106. Upon actuation of the button 212, the circuit board 210 drives the liquid suction and discharge component 106 to generate a suction force, thereby drawing skincare liquid from the bottle body 108 through the liquid guide tube 104 and into the heating chamber 110. In this configuration, the suction force is generated automatically without requiring manual squeezing or mechanical actuation by the user. The powered suction operation enables accurate and repeatable intake of a predetermined amount of skincare liquid into the heating chamber 110, improves user convenience, and ensures stable liquid transfer, particularly for high-viscosity skincare formulations. The powered suction function may operate independently or in coordination with the heating assembly 102 under the control of the circuit board 210.

The power management module 208 may include the button 212 and the charging component 214 integrated with or adjacent to the button 212. The button 212 is operable to selectively activate or deactivate the heating element 134, thereby realizing power-on and power-off control of the heating cap. The charging component 214 is configured to connect to an external power source to recharge the battery 206, thereby enabling convenient and repeated use of the device.

By incorporating the battery 206 and the power management module 208, the present embodiment achieves independent power supply, intelligent power management, and convenient charging functionality, thereby enhancing portability and improving overall user convenience.

In an embodiment, the functional cap further includes a phototherapy assembly disposed within the cap body. The heating chamber includes an end plate that covers a mounting port at the top of the outer shell. The end plate includes a first flange circumferentially arranged around the heating chamber, wherein a side edge of the first flange is connected to an edge of the mounting port. The first flange is light-transmitting to allow light to pass through. The phototherapy assembly includes a phototherapy lamp plate arranged circumferentially around the heating chamber and corresponding to the first flange. The phototherapy lamp plate includes a plurality of LED beads facing the first flange. The LED beads are configured to indicate a heating status of the heating element or to provide phototherapy to a user's skin.

In an embodiment, the LED beads are configured to emit different colors of light according to different operating states. For example, during heating, the LED beads may flash green light and emit light through the first flange to indicate to the user that the heating process is in progress. After heating is complete, the LED beads may change to a specific color, such as red light or blue light, to achieve a phototherapy effect and further enhance the skincare experience. Red light may help promote blood circulation and collagen production, while blue light may be used for antibacterial and anti-inflammatory purposes.

In an embodiment, the LED beads include a first LED bead and a plurality of second LED beads arranged in a ring around the heating chamber. The first LED bead is configured to indicate the heating status of the heating element or for phototherapy, and the second LED beads are configured for phototherapy. During heating, the first LED bead flashes green light and emits light through the first flange to indicate to the user that the heating process is in progress. After heating is completed, the first LED bead and the second LED bead may light up together in the same color to achieve the phototherapy effect.

In an embodiment, the phototherapy assembly further includes a light shield disposed over the heating chamber. The light shield has a second flange corresponding to the first flange, and the second flange has a light-transmitting hole. The phototherapy lamp plate is arranged around the light shield and disposed on a side of the second flange facing away from the first flange. The LED beads are disposed within the light-transmitting hole. The heating element is disposed between the heating chamber and the light shield. The light shield serves to fix the phototherapy lamp plate and shield the light, effectively preventing unnecessary light leakage and allowing the light to be concentrated in a designated area, thereby improving the phototherapy effect.

In an embodiment, the end plate is provided with at least one ball groove. A wall of the ball groove is provided with a liquid outlet hole that communicates with the heating chamber. A ball is disposed in the ball groove for massage. When the skincare product container is tilted or inverted, the skincare product flows out through the liquid outlet hole. The ball is located in the ball groove, allowing users to massage their face or skin while using skincare products, thereby enhancing the comfort and effectiveness of the skincare process.

In an embodiment, the light shield is provided with a guide tube and a limiting tube on a side away from the second flange. The guide tube is slidably connected to the liquid guide tube. The limiting tube is disposed within the guide tube and includes a first limiting cavity and a second limiting cavity that are connected. The heating chamber is provided with a positioning tube on a side away from the end plate. The positioning tube is connected to the first limiting cavity. The liquid suction and discharge assembly includes a liquid pump disposed inside the liquid guide tube and connected to the heating chamber. One end of the liquid pump is connected to the second limiting cavity. This configuration realizes the moving guidance of the outer shell and the limiting installation of the heating chamber and the liquid pump, while ensuring the compactness of the structure and the reliability of the function.

In an embodiment, the heat-insulating structure further includes an insulation column that fills a central space of the spiral-shaped heat-conducting part. The insulation column may be made of a material with good thermal insulation properties, such as silicone, aerogel, or foam plastic. These materials have low thermal conductivity, which can significantly reduce the rate at which heat is conducted outward, thereby improving heating efficiency. The insulation column is precisely placed within the internal gaps of the spiral heat-conducting part, effectively filling the original air gaps. This helps reduce heat loss along the heat conduction path, allowing heat to be transferred more concentratedly to the skincare liquid inside the heat-conducting part, shortening the heating time and achieving rapid heating.

In an embodiment, the insulation box includes an insulation cover located at a top opening thereof. The insulation cover can be opened or closed to facilitate assembly of the heat-conducting part of the liquid guide tube. The insulation cover has a through hole for connecting the second end of the liquid guide tube to the liquid suction and discharge component, allowing the user to control the intake and discharge of the skincare liquid while maintaining the closed state of the insulation box.

In an embodiment, the heat-conducting part of the liquid guide tube may be designed with a spiral shape in a roughly vertical direction or in a roughly horizontal direction. The specific design can be adjusted according to actual needs and spatial constraints within the cap body. The spiral design, whether vertical or horizontal, significantly increases the contact area, allowing heat to be transferred more evenly and quickly to the skincare liquid within the heat-conducting part.

In an embodiment, the liquid suction and discharge component may be implemented as an elastic telescopic cap having a bellows-style or accordion-shaped flexible section. The corrugated or pleated section allows for compression and expansion during operation, enabling the drawing in and expulsion of skincare liquids. This type of liquid suction and discharge component operates by compressing the bellows section to create pressure changes that draw skincare liquid from the bottle body into the heating chamber through the liquid guide tube and subsequently discharge the heated liquid for user application. The design allows for controlled intake and output of skincare liquids through simple manual compression and release actions.

In one embodiment, the heating chamber is configured to store a predetermined quantity of skincare liquid drawn from the bottle body. The predetermined quantity is defined by the volumetric capacity of the heating chamber and is selectively retained therein under the control of the stop-flow vent valve, which prevents excess liquid from remaining in the liquid guide tube while allowing only the intended amount of skincare liquid to be stored within the heating chamber.

The stop-flow vent valve, by selectively controlling liquid and air communication between the heating chamber and the liquid guide tube, ensures that only a metered volume of skincare liquid remains inside the heating chamber after completion of the extraction stage. This predetermined volume may correspond to a single-use dose, a multi-use dose, or any quantity suitable for localized application.

In certain embodiments, the heating chamber is not limited to functioning solely as a heating cavity, but may further function as a treatment chamber configured to subject the stored skincare liquid to one or more additional processing steps prior to discharge.

For example, in addition to thermal treatment, the heating chamber may be configured to facilitate mixing of the stored skincare liquid with an additional ingredient introduced through a secondary inlet, micro-channel, capsule-breaking mechanism, or dissolvable cartridge. Such mixing may occur before, during, or after heating.

In another embodiment, the heating chamber may be configured to include a phototherapy element arranged to emit light into the stored skincare liquid, thereby activating photo-responsive ingredients, accelerating precursor conversion, enhancing bioavailability, or inducing controlled photochemical reactions prior to dispensing.

In further embodiments, the treatment chamber may include one or more additional stimulation elements selected from ultrasonic transducers, microcurrent electrodes, vibration modules, magnetic field generators, plasma treatment elements, ionization elements, or mechanical agitation structures configured to further process, homogenize, activate, or condition the stored skincare liquid.

In certain embodiments, the heating chamber may therefore operate as a multifunctional processing chamber configured to apply one or more treatments including heating, mixing, phototherapy activation, aeration, emulsification, etc. or combinations thereof, before the skincare liquid is discharged for application.

The sequence, duration, and combination of such treatments may be controlled by the control circuit according to preset parameters or user selection, thereby enabling customized formulation preparation immediately prior to use.

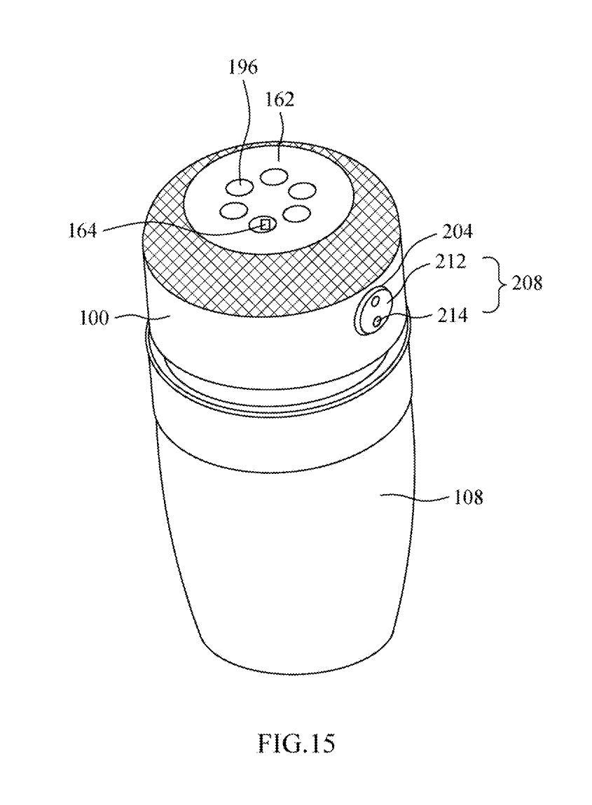

Referring to FIGS. 15 to 17, in an embodiment, an alternate configuration of the functional cap is provided with a bottle body 108 and a cap body 100. The bottle body 108 is provided with a bottle mouth portion 114 at the top end thereof. The cap body 100 comprises an outer shell 144 and a base 146. The outer shell 144 is slidably sleeved over the base 146, such that the outer shell 144 is movable relative to the base 146 in an axial direction. The top portion of the outer shell 144 is provided with an installation port. The base 146 is configured to surround and engage the bottle mouth portion 114, for example, by threaded engagement or a snap-fit connection, thereby forming a sealed connection with the bottle body 108.

In an embodiment, a heating assembly 102 is disposed in a space defined between the outer shell 144 and the base 146. A liquid guide tube 104 passes through the base 146 and fluidly connects the bottle body 108 with the heating assembly 102.

The heating assembly 102 includes a heating chamber 110 and associated heating elements. The heating chamber 110 includes an end plate 162 covering the installation port of the outer shell 144. The end plate 162 is provided with a liquid outlet hole 164 in fluid communication with the heating chamber 110, such that a heated skincare product may be discharged therefrom.

The liquid suction and discharge component106 includes a liquid pump 166. The liquid pump 166 is disposed within the liquid guide tube 104 and is fluidly connected to the heating chamber 110. The liquid pump 166 may operate like a conventional pump dispenser, such as a shampoo-type pump, wherein liquid is drawn and expelled through reciprocating or pressing actions.

Specifically, when a user presses the outer shell 144, the outer shell 144 moves downward relative to the base 146, thereby driving the heating chamber 110 downward and actuating the liquid pump 166 disposed within the liquid guide tube 104. Under this actuation, the skincare product is drawn from the bottle body 108 through the liquid guide tube 104 into the heating chamber 110, where it is heated by the heating element 134. The heated skincare product is then discharged through the liquid outlet hole 164 for application.

Through the above configuration, the skincare product stored in the bottle body 108 is introduced into the cap body 100 for localized heating, thereby avoiding repeated heating of the entire contents of the bottle body 108. This improves heating efficiency, maintains product stability, and prevents degradation of heat-sensitive ingredients. The instant heating function further ensures that a warmed skincare product is available upon each use, thereby enhancing overall user experience.

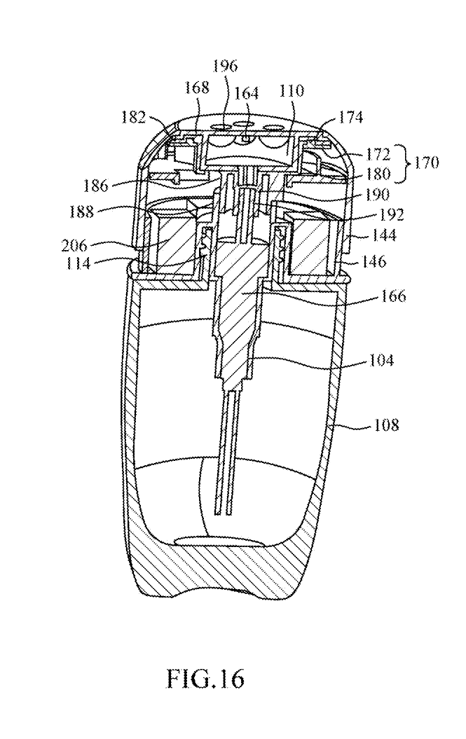

In some embodiments, referring to FIG. 16, the end plate 162 includes a first flange 168 circumferentially arranged around the heating chamber 110. A side edge of the first flange 168 is connected to an edge of the installation port. The first flange 168 is formed from a light-transmitting material.

The cap body 100 further includes a phototherapy assembly 170 disposed within the cap body. The phototherapy assembly 170 includes a phototherapy lamp plate 172 circumferentially arranged around the heating chamber 110 and corresponding to the first flange 168. The phototherapy lamp plate 172 includes a plurality of LED beads 174 facing toward the first flange 168.

The LED beads 174 are configured to emit light through the first flange 168. In some implementations, the emitted light serves as a visual indicator of the operating status of the heating element 134, such as heating activation, standby mode, or temperature attainment. In other implementations, the LED beads 174 are configured to provide phototherapy to a user’s skin during the dispensing of the heated skincare product.

By integrating the phototherapy assembly 170 with the heating assembly 102, the present embodiment combines localized heating and light-based treatment functions within a compact cap structure, thereby enhancing functional versatility and improving the overall skincare effect.

Specifically, the first flange 168 of the end plate 162 is formed from a light-transmitting material to ensure that light emitted by the phototherapy assembly 170 can pass through efficiently. In an alternative embodiment, the entire end plate 162 and/or the heating chamber 110 may be formed from a light-transmitting material, thereby further improving light transmission efficiency and simplifying structural processing and manufacturing.

The LED beads 174 may be configured to emit light of different colors according to operational requirements. For example, during operation of the heating element 134, the LED beads 174 may emit flashing green light, which passes through the first flange 168 to provide a visual indication that the heating process is in progress. After completion of heating, the LED beads 174 may emit light of another predetermined color, such as red or blue light, to provide a phototherapy effect while simultaneously indicating completion of heating.

In some implementations, red light emission may be used to promote blood circulation and stimulate collagen production, while blue light emission may be used to provide antibacterial and anti-inflammatory effects. It should be understood that the selection of light wavelength and colour may be adjusted according to desired therapeutic or cosmetic effects.

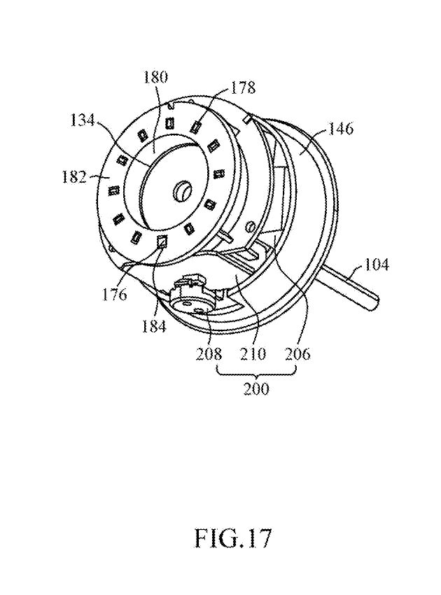

In one example, referring to FIG. 17, the LED beads 174 comprise a first LED 176 and a plurality of second LEDs for phototherapy. The plurality of second LEDs 178 is primarily configured to provide phototherapy.

During heating, the first LED 176 may emit flashing green light through the first flange 168 to indicate that the heating process is ongoing. After the heating process is completed, the first LED 176 and the second LEDs 178 may be simultaneously illuminated in a selected colour, such as red or blue, thereby providing a phototherapy function in conjunction with the heated skincare product.

Through the above-described lighting configuration, the user may intuitively perceive the operational status of the device via visual signals, thereby enhancing human-machine interaction. At the same time, integration of phototherapy functionality with the heating function enables simultaneous thermal treatment and light-based treatment, thereby improving overall skincare effectiveness, increasing user satisfaction, and meeting diverse usage requirements.

In some embodiments, as shown in FIGS. 16 and 17, the phototherapy assembly 170 further comprises a light shield 180. The light shield 180 covers at least a portion of the

heating chamber 110 and includes a second flange 182 corresponding in position to the first flange 168 of the end plate 162. The second flange 182 is provided with at least one light-transmitting hole 184.

The phototherapy lamp plate 172 is arranged around the light shield 180 and is disposed on a side of the second flange 182 facing away from the first flange 168. The LED beads 174 are inserted into the light-transmitting hole 184 such that light emitted therefrom is aligned with and transmitted through the first flange 168. The heating element 134 is arranged between the heating chamber 110 and the light shield 180.

Specifically, the light shield 180 is mounted on the heating chamber 110, and the second flange 182 serves both to secure the phototherapy lamp plate 172 and to provide optical shielding. The light-transmitting hole 184 is configured to position and support the first LED 176 and the second LED 178, ensuring accurate alignment with the first flange 168, thereby facilitating efficient and directed light transmission.

The light shield 180 advantageously reduces or prevents undesired light leakage, enabling emitted light to be concentrated within a designated irradiation area, thereby improving the phototherapy effect. In some embodiments, the heating element 134 may comprise a heating plate disposed between a bottom portion of the heating chamber 110 and the light shield 180. This configuration promotes efficient heat transfer to the skincare product contained within the heating chamber 110 while thermally isolating the phototherapy lamp plate 172 from excessive heat, thereby ensuring stable and reliable operation of the phototherapy assembly 170.

Accordingly, by means of the structural configuration of the light shield 180, stable mounting of the phototherapy lamp plate 172 is achieved, optical efficiency is improved, and overall safety and operational reliability of the device are enhanced.

In some embodiments, as shown in FIG. 16, the light shield 180 further includes a guide tube 186 and a limiting tube 188 disposed on a side thereof facing away from the second flange 182. The guide tube 186 is slidably connected to the liquid guide tube 104. The limiting tube 188 is arranged within the guide tube 186 and includes a first limiting cavity 190 and a second limiting cavity 192 that are in communication with each other.

The heating chamber 110 is provided with a positioning tube on a side thereof facing away from the end plate 162. The positioning tube is connected to the first limiting cavity 190, and one end of the liquid pump 166 is connected to the second limiting cavity 192.

Specifically, the guide tube 186 is slidably received within the liquid guide tube 104, thereby allowing skincare liquid to smoothly enter and exit the heating chamber 110. At the same time, the guide tube 186 provides a stable guiding structure for axial movement of the outer shell 144, ensuring smooth and unobstructed operation when the user presses and releases the outer shell 144.

The limiting tube 188 functions to accurately position and secure both the heating chamber 110 and the liquid pump 166, preventing displacement during operation. This structural arrangement enhances positional stability and improves the accuracy and consistency of liquid extraction and discharge.

Through the above configuration, the embodiments not only realize guided movement of the outer shell 144 and precise positioning of the heating chamber 110 and liquid pump 166, but also achieve structural compactness and functional reliability, thereby improving overall device performance.

In some embodiments, as shown in FIGS. 15 and 16, the end plate 162 is provided with at least one ball groove 196. A wall portion of the ball groove 196 is provided with at least one liquid outlet hole 164. A ball (not shown) is rotatably received within the ball groove 196 and is configured to provide a massage function during use.

Specifically, the ball groove 196 is formed in the end plate 162 and is configured to accommodate the ball in a partially exposed manner, such that a portion of the ball protrudes outwardly from the end plate 162. The liquid outlet hole 164 communicates with the heating chamber 110 or the liquid flow path and is arranged on the wall of the ball groove 196. When the container is tilted or inverted, the skincare product is permitted to flow out through the liquid outlet hole 164 under the action of gravity.

In operation, when a user presses the outer shell 144, the liquid pump 166 is actuated to draw the skincare product from the bottle body 108 through the liquid guide tube 104 into the ball groove 196. The skincare product is thereby delivered to the vicinity of the ball and the liquid outlet hole 164 for application. During use, the user may tilt or invert the container to allow the skincare product to discharge through the liquid outlet hole 164. Simultaneously, the exposed portion of the ball can roll along the surface of the skin, providing a massaging effect while evenly spreading the skincare product.

The rolling ball structure not only facilitates uniform application of the heated skincare product but also promotes local blood circulation and enhances absorption efficiency, thereby improving the overall skincare effect. Accordingly, the described configuration integrates heating, phototherapy, liquid dispensing, and massage functions into a single structure, thereby satisfying diverse user requirements and significantly enhancing user experience.

In some embodiments, the bottle cap further comprises a protective cap detachably fitted onto the cap body 100.

Specifically, the protective cap is configured to cover the end plate 162, including the ball groove 196 and associated structures. When the user intends to perform skincare, the protective cap may be removed to expose the ball and dispensing components. After use, the protective cap may be reattached to the cap body 100 to seal and protect the internal structures from dust, contamination, and external environmental influences.

By virtue of the protective cap, the device not only ensures convenient operation during use but also provides effective sealing and hygienic protection when not in use, thereby improving product safety, cleanliness, and durability.

In some embodiments, as shown in FIGS. 4A to 4C and 17, the bottle cap further comprises an electronic control component 200 disposed within the cap body 100 and configured to control operation of the bottle cap. The integration of the electronic control component 200 enhances functional controllability and improves overall user interaction and operational convenience.

In some embodiments, referring to FIGS. 4A to 4C, the mounting part 156 is provided with the fixing hole 202, and a top portion of the outer shell 144 is provided with the positioning hole 204 corresponding to and communicating with the fixing hole 202. The electronic control component 200 comprises the battery 206, the power management module 208, and the circuit board 210. The battery 206 is disposed inside the cap body 100.

The power management module 208 includes the button 212 and the charging component 214. The button 212 is disposed within the fixing hole 202 and extends through the positioning hole 204 so as to be exposed at the exterior surface of the outer shell 144 for user operation. The charging component 214 is arranged on or integrated with the button 212. The charging component 214 may comprise, for example, a charging port, charging terminal, charging electrode, magnetic charging interface, or other suitable charging structure.

The circuit board 210 is disposed inside the cap body 100 and is electrically connected to the heating element 134, the battery 206, the button 212, and the charging component 214, respectively. The circuit board 210 may be fixed to the base 146 via the bracket 216 and is configured to coordinate and control the operation of the heating assembly and associated functional modules. By actuating the button 212, a user may control operational states of the heating element 134, including power on/off and heating intensity adjustment. The battery 206 supplies power to the device and may be recharged via the charging component 214.

In some embodiments, referring to FIGS. 15 to 17, a side wall of the outer shell 144 is provided with the positioning hole 204 for accommodating the power management module 208. In this configuration, the electronic control component 200, similarly, comprises the battery 206, the power management module 208, and the circuit board 210, with the battery 206 disposed inside the cap body 100. The button 212 is arranged within the positioning hole 204 and exposed at the outer surface of the outer shell 144, and the charging component 214 is integrated with the button 212.

The circuit board 210 is electrically connected to the heating element 134, the phototherapy lamp plate 172, the battery 206, the button 212, and the charging component 214, respectively, thereby enabling coordinated control of heating and phototherapy functions. During heating, the LED beads 174 of the phototherapy lamp plate 172 may emit or flash light of a first colour (e.g., green) to indicate that heating is in progress. Upon completion of heating, the LED beads 174 may emit light of a second colour (e.g., red or blue) to perform a phototherapy function. The battery 206 is rechargeable through the charging component 214.

Accordingly, the above configurations enable compact installation of the electronic control component 200, intelligent management of heating and phototherapy operations, simplified user interaction, and efficient device performance.

In some embodiments, the electronic control component 200 can further comprises the temperature sensor 228 disposed on or adjacent to the heating chamber 110. The temperature sensor 228 is electrically connected to the circuit board 210 and configured to monitor the temperature of the heating chamber 110. The circuit board 210 adjusts the operation of the heating element 134 based on detected temperature data, such that the skincare product within the heating chamber 110 reaches and maintains a predetermined temperature, thereby achieving precise temperature control and improving safety and user experience.

In some embodiments, referring to FIGS. 1A, 1B, and 15, a container is provided, comprising the bottle body 108 and the bottle cap according to any of the foregoing embodiments. The bottle body 108 is configured to store a skincare product, and the bottle cap is detachably or fixedly connected to the bottle body 108. Through cooperation of the bottle body 108 and the multifunctional bottle cap, localized heating, phototherapy, dispensing, and optional massage functions may be achieved without repeatedly heating the entire contents of the bottle, thereby improving product stability and usage efficiency.

Additionally, in an embodiment, the functional cap may further comprise a plurality of liquid guide tubes configured to extend into the bottle body or into separate internal compartments of the bottle body. The plurality of liquid guide tubes may include a first liquid guide tube and a second liquid guide tube, each configured to draw a different skincare liquid into the cap body.

In an embodiment, the functional cap may comprise a plurality of independent heating chambers respectively connected to separate liquid guide tubes. Each heating chamber may include an independent heating element and control structure, thereby enabling sequential heating of different skincare formulations. In such an arrangement, a first skincare liquid may be heated and dispensed during a first operation cycle, and a second skincare liquid may be heated and dispensed during a subsequent cycle.

In a further embodiment, the control system may be configured to selectively activate one liquid guide tube and corresponding heating chamber at a time, thereby preventing unintended mixing and allowing controlled multi-step skincare treatment. This structure enables layered application protocols, professional treatment procedures, or customized skincare regimens.

Alternatively, in an embodiment, the heating chamber may be configured as a mixing chamber, such that skincare liquid drawn through the first liquid guide tube and skincare liquid drawn through the second liquid guide tube are combined within the heating chamber prior to heating. This configuration allows two different formulations, such as a serum and an activator, or an essence and an oil component, etc., to be mixed immediately before use, thereby preserving the stability of reactive or sensitive ingredients during storage.

In an embodiment, the functional cap may further comprise an electrical protection module electrically connected to the heating element. The electrical protection module may include overcurrent protection circuitry configured to automatically interrupt the power supply to the heating element when current exceeds a predetermined threshold, thereby preventing overheating, short circuit, or component damage.

In an embodiment, the functional cap may further comprise a dry-heating detection mechanism configured to detect the absence of skincare liquid within the heating chamber. The dry heating detection mechanism may include a temperature gradient detection algorithm, a resistance monitoring system, or a liquid presence sensor. When insufficient liquid is detected, the control circuit may automatically disable the heating element to prevent dry burning and prolong service life.

In an embodiment, the functional cap may further comprise an automatic shut-off timer configured to deactivate the heating element after a predetermined heating duration or after reaching a preset temperature for a predefined time interval. This feature enhances user safety and reduces unnecessary energy consumption.

In an embodiment, the cap body further includes a charging interface, such as a USB charging port, disposed on an outer surface of the cap body. The USB charging port may be configured to receive electrical power from an external power source for recharging the rechargeable lithium battery.

In an embodiment, the functional cap may include a wireless charging receiver module disposed within the cap body and electrically connected to the rechargeable battery. The wireless charging receiver module may be configured to receive electromagnetic energy from an external wireless charging base, thereby enabling cable-free charging.

In an embodiment, the functional cap may further comprise one or more visual indicators, such as LED indicator lights disposed on the cap body. The LED indicator lights may be configured to indicate operational states, including power status, heating progress, temperature attainment, battery level, or fault conditions.

In an embodiment, the functional cap may further comprise an audible notification component, such as a buzzer or speaker module, electrically connected to the control circuit. The audible notification component may be configured to generate a sound signal upon completion of heating, detection of abnormal operation, or completion of a dispensing cycle, thereby improving user convenience.

Accordingly, the present invention provides a compact, integrated, and highly efficient functional cap for heating and dispensing skincare liquids, which overcomes the limitations of conventional containers that require heating of an entire product volume or lack precise dispensing control. Through the coordinated arrangement of the cap body, heating assembly, valve-controlled liquid flow system, liquid guide tube, and optional electronic control and temperature regulation components, the invention enables selective, rapid, and uniform heating of only a required portion of liquid while preserving the quality and efficacy of the remaining contents. The invention is well-suited for large-scale industrial manufacture using conventional molding, assembly, and electronic integration processes, and may be widely applied in cosmetic, skincare, pharmaceutical, personal care, and wellness product packaging. Its modular and adaptable structure allows integration with various container types and formulations, making it commercially viable, energy efficient, and highly suitable for repeated consumer use in domestic, professional, and industrial settings.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A functional cap for heating and dispensing skincare liquids, comprising:
a cap body configured to attach to a bottle body;
a heating assembly disposed within the cap body, the heating assembly comprising a heating chamber and a heating element configured to heat the heating chamber;
a liquid guide tube connected to the heating chamber, wherein one end of the liquid guide tube remote from the heating chamber is configured to extend into the bottle body; and
a stop-flow vent valve connected between the heating chamber and the liquid guide tube, the stop-flow vent valve comprising a valve body and a valve core, wherein the valve core is movable to control liquid and air flow.

2. The functional cap of claim 1, wherein the heating element comprises one of a heating wire, a heating plate, a heating rod, a heating film, or a ceramic heating element.

3. The functional cap of claim 1, further comprising a liquid suction and discharge component disposed on the cap body and connected to the heating chamber, wherein the liquid suction and discharge component is configured to control skincare liquid in the bottle body to be drawn into the heating chamber or to control skincare liquid in the heating chamber to be discharged.

4. The functional cap of claim 3, wherein the liquid suction and discharge component comprises one of a pressing cap, dropper, a pump disposed on the cap body and connected to the heating chamber, or a push-pull rod and a piston, wherein the piston is slidably disposed within the heating chamber, and wherein the push-pull rod is connected to the piston and extends through the cap body.

5. The functional cap of claim 1, wherein the liquid guide tube comprises a plurality of tube segments sequentially connected and configured to extend or retract relative to one another.

6. The functional cap of claim 1, wherein the heating assembly comprises a phase-change material configured to release heat during a phase transition.

7. The functional cap of claim 1, wherein the heating assembly further comprises a heat insulation box surrounding the heating chamber, and wherein the heating element is disposed between the heating chamber and the heat insulation box.

8. The functional cap of claim 7, wherein the heating assembly further comprises a heat-conducting seat disposed within the heat insulation box, the heat-conducting seat being sleeved around the heating chamber, and wherein the heating element is mounted on the heat-conducting seat.

9. The functional cap of claim 8, further comprising a thermally conductive structure layer disposed between the heat-conducting seat and the heating chamber.

10. The functional cap of claim 1, wherein the valve body includes a main flow chamber and a bypass chamber, wherein one end of the main flow chamber is connected to the heating chamber and another end of the main flow chamber is connected to the liquid guide tube, wherein a first vent is formed between the bypass chamber and the main flow chamber, and wherein a second vent is formed on a side of the bypass chamber at a distance from the first vent, and wherein the valve core is movable within the bypass chamber to switch between a first position blocking the first vent, a second position opening both the first vent and the second vent, and a third position blocking the second vent.

11. A functional cap for heating and dispensing skincare liquids, comprising:
a cap body configured to attach to a bottle body;
a liquid guide tube and a liquid suction and discharge component, wherein the liquid guide tube includes a first end, a second end, and a heating chamber comprising a heat-conducting part disposed between the first end and the second end, wherein the heat-conducting part is disposed within the cap body, wherein the first end passes through the cap body and is configured to extend into the bottle body, and wherein the liquid suction and discharge component is connected to the second end and exposed on the cap body, the liquid suction and discharge component configured to draw skincare liquid from the bottle body into the heat-conducting part through the first end or to discharge skincare liquid from the heat-conducting part through the first end; and
a heating structure comprising a heating element disposed on the heat-conducting part.

12. The functional cap of claim 11, wherein the heat-conducting part is spiral-shaped, and the heating element is selected from a heating wire, a heating plate, or a heating rod, wherein the heating element is arranged along and wound around the heat-conducting part.

13. The functional cap of claim 11, further comprising a heat-insulating structure disposed inside the cap body and configured to insulate the heat-conducting part, wherein the heat-insulating structure comprises an insulation box surrounding the heat-conducting part.

14. The functional cap of claim 13, further comprising an insulation column that fills a central space of the heat-conducting part.

15. The functional cap of claim 11, further comprising a temperature sensor disposed on the heat-conducting part and a circuit board disposed within the cap body and electrically connected to the temperature sensor and the heating element.

16. A functional cap for heating and dispensing skincare liquids, comprising:
a cap body configured to attach to a bottle body;
a heating chamber disposed within the cap body;
a liquid guide tube connected to the heating chamber, wherein one end of the liquid guide tube is configured to extend into the bottle body;
a liquid suction and discharge component disposed on the cap body and connected to the heating chamber; and
a stop-flow vent valve connected between the heating chamber and the liquid guide tube, the stop-flow vent valve configured to discharge residual skincare liquid from the liquid guide tube while retaining skincare liquid in the heating chamber for heating.

17. The functional cap of claim 16, wherein the stop-flow vent valve is selected from a group consisting of but is not limited to a non-return valve (NRV), check valve, one-way valve, duckbill valve, diaphragm valve, spring-loaded valve, gravity-biased valve, solenoid valve.

18. The functional cap of claim 16, wherein the stop-flow vent valve comprises a valve body including a main flow chamber and a bypass chamber, wherein one end of the main flow chamber is connected to the heating chamber and another end of the main flow chamber is connected to the liquid guide tube, wherein a first air hole is connected between the bypass chamber and the main flow chamber, and wherein a second air hole is provided on a side of the bypass chamber remote from the first air hole.

19. The functional cap of claim 18, further comprising a valve core movably disposed within the bypass chamber and configured to switch between a first position blocking the first air hole, a second position opening both the first air hole and the second air hole, and a third position blocking the second air hole.

20. The functional cap of claim 19, wherein during a skincare liquid extraction stage, the valve core moves to the first position to seal the first air hole; wherein during a stopping extraction stage, the valve core moves to the second position to connect the first air hole and the second air hole, allowing residual skincare liquid in the liquid guide tube to drain by gravity while retaining skincare liquid in the heating chamber; and wherein during a skincare liquid discharge stage, the valve core moves to the third position to block the second air hole.
